(19) United States
(12) Patent Application Publication
(10) Pub. No.: US 2023/0081876 A1
(43) Pub. Date: Mar. 16, 2023

(54) REMOTE ASSISTANCE SYSTEM AND PROGRAM

(71) Applicant: DENSO CORPORATION, Kariya-city (JP)

(72) Inventor: Masato MATSUMOTO, Kariya-city (JP)

(21) Appl. No.: 18/046,052

(22) Filed: Oct. 12, 2022

Related U.S. Application Data
(63) Continuation of application No. PCT/JP2021/013368, filed on Mar. 29, 2021.

(30) Foreign Application Priority Data
Apr. 14, 2020 (JP) 2020-072574

(51) Int. Cl. G05D 1/00

(52) U.S. Cl. CPC G05D 1/0038

(57) ABSTRACT

In a remote assistance apparatus, a task assigning unit prohibits assignment of a task to an operator whose operational capability is judged to be insufficient by newest evaluation results that are stored in a storage unit, and assigns a task of remotely controlling a vehicle to an operator who is selected from among a plurality of operators whose operating abilities are judged to be sufficient by the newest evaluation results. An evaluation acquiring unit acquires the evaluation result of the operational capability of the selected operator, in response to the selected operator performing the task that is assigned by the task assigning unit using a remote control unit that causes the vehicle to travel in response to remote control by the operator. A storage control unit performs control to store the newest evaluation result acquired by the evaluation acquiring unit in the storage unit.

### CROSS-REFERENCE TO RELATED APPLICATION

The present application is a continuation application of International Application No. PCT/JP2021/013368, filed on Mar. 29, 2021, which claims priority to Japanese Patent Application No. 2020-072574, filed on Apr. 14, 2020. The contents of these applications are incorporated herein by reference in their entirety.

### BACKGROUND

### Technical Field

The present disclosure relates to a remote assistance apparatus and a program.

### Related Art

A remote assistance system has been proposed in which an operator who is in a remote location supports an autonomous driving vehicle when the autonomous driving vehicle faces an unforeseen event or the like. In the remote assistance system, for example, assignment of an operator to handle remote assistance of a vehicle may be performed based on a suitability value that is calculated based on operator experience.

### SUMMARY

One aspect of the present disclosure provides a remote assistance apparatus. The remote assistance apparatus prohibits assignment of a task to an operator whose operational capability is judged to be insufficient by newest evaluation results that are stored in a storage unit, and assigns a task of remotely controlling a vehicle to an operator who is selected from among a plurality of operators whose operating abilities are judged to be sufficient by the newest evaluation results. The remote assistance apparatus acquires the evaluation result of the operational capability of the selected operator, in response to the selected operator performing the task that is assigned by the task assigning unit using a remote control unit that causes the vehicle to travel in response to remote control by the operator. The remote assistance apparatus performs control to store the newest evaluation result acquired by the evaluation acquiring unit in the storage unit.

### BRIEF DESCRIPTION OF THE DRAWINGS

In the accompanying drawings:

FIG. 1 is a block diagram illustrating an example of a configuration of a remote assistance system;

FIG. 2 is a block diagram illustrating an example of an electrical configuration of each section of the remote assistance system;

FIG. 3 is a block diagram illustrating an example of a functional configuration of each section of the remote assistance system;

FIG. 4 is an example illustrating a table that holds operator information;

FIG. 5 is a flowchart illustrating an example of a flow of processes of a remote assistance program;

FIG. 6 is a diagram illustrating an example of a screen that is displayed to an operator;

FIG. 7 is a diagram illustrating an example of a screen that is displayed to the operator;

FIG. 8 is a diagram illustrating a state that serves as a premise for evaluation;

FIG. 9 is a flowchart illustrating an example of a flow of an evaluation acquiring process;

FIG. 10 is a flowchart illustrating another example of the flow of the evaluation acquiring process;

FIG. 11 is a diagram illustrating a state that serves as a premise for evaluation according to a second embodiment;

FIG. 12 is a flowchart illustrating an example of a flow of an evaluation acquiring process according to the second embodiment;

FIG. 13 is a diagram illustrating a state that serves as a premise for evaluation according to a third embodiment;

FIG. 14 is a flowchart illustrating an example of a flow of an evaluation acquiring process according to the third embodiment;

FIG. 15 is a flowchart illustrating an example of a flow of an evaluation acquiring process according to a fourth embodiment;

FIG. 16 is an example illustrating a table of scores of determination items and an overall score;

FIG. 17 is a flowchart illustrating an example of a flow of an evaluation acquiring process according to a fifth embodiment;

FIG. 18 is a flowchart illustrating an example of a flow of a return-to-duty process;

FIG. 19 is a flowchart illustrating an example of a flow of an examining process;

FIG. 20 is a diagram illustrating an example of a screen that is displayed to an operator;

FIG. 21 is a diagram illustrating an example of a screen that is displayed to the operator;

FIG. 22 is a diagram illustrating an example of a screen that is displayed to the operator;

FIG. 23 is a diagram illustrating an example of a screen that is displayed to the operator;

FIG. 24 is a diagram illustrating a display example of an evaluation result;

FIG. 25 is a diagram illustrating another display example of the evaluation result; and

FIG. 26 is a flowchart illustrating an example of a flow of a remote assistance program according to a seventh embodiment.

### DESCRIPTION OF THE EMBODIMENTS

A remote assistance system has been proposed in which an operator who is in a remote location supports an autonomous driving vehicle when the autonomous driving vehicle faces an unforeseen event or the like has. JP-A-2019-175209 discloses a remote assistance system that includes an assignment control unit that performs assignment of an operator to handle remote assistance of a vehicle based on a suitability value that is calculated based on operator experience.

In the remote assistance system disclosed in JP-A-2019-175209, a suitable operator can be assigned to each vehicle based on operator experience. Remote assistance for each vehicle can be efficiently performed. However, even in a case of an experienced operator, operational capability may decrease due to ill health, drowsiness, or the like. In addition, the operator does not easily realize there is a decrease in their own operational capability. As a result of detailed review by the inventors, an issue has been found in that operators who are in a state of decreased operational capability cannot be avoided in the remote assistance system disclosed in JP-A-2019-175209.

It is thus desired to provide a remote assistance apparatus that is capable of assigning a task of remotely controlling a vehicle to an operator who has guaranteed operational capability, and a program.

A first exemplary embodiment of the present disclosure provides a remote assistance apparatus that includes: a task assigning unit that prohibits assignment of a task to an operator whose operational capability is judged to be insufficient by newest evaluation results that are stored in a storage unit, and assigns a task of remotely controlling a vehicle to an operator who is selected from among a plurality of operators whose operating abilities are judged to be sufficient by the newest evaluation results; an evaluation acquiring unit that acquires the evaluation result of the operational capability of the selected operator, in response to the selected operator performing the task that is assigned by the task assigning unit using a remote control unit that causes the vehicle to travel in response to remote control by the operator; and a storage control unit that performs control to store the newest evaluation result acquired by the evaluation acquiring unit in the storage unit.

In the remote assistance apparatus, the evaluation acquiring unit may acquire, using a simulator unit that performs a simulation that causes the vehicle to travel in a virtual environment in response to operation by the operator, a new evaluation result of operational capability of: an operator whose operational capability is judged to be insufficient by the newest evaluation results; or an operator whose new evaluation result of operational capability has not been acquired for an amount of time prescribed in advance or longer.

A second exemplary embodiment of the present disclosure provides a remote assistance apparatus that includes: a task assigning unit that assigns a task of remotely controlling a vehicle to an operator who is selected from among a plurality of operators whose operating abilities are judged to be sufficient by newest evaluation results that are stored in a storage unit; an evaluation acquiring unit that acquires the evaluation result of the operational capability of the selected operator, in response to the selected operator performing the task that is assigned by the task assigning unit, using a remote control unit that causes the vehicle to travel in response to remote control by the operator, and acquires the evaluation result of the operational capability of the operator who performs a simulation, in response to the operator performing the simulation using a simulator unit that performs a simulation that causes the vehicle to travel in a virtual environment in response to operation by the operator; and a storage control unit that performs control to store the newest evaluation result acquired by the evaluation acquiring unit in the storage unit.

A third exemplary embodiment of the present disclosure provides a non-transitory computer-readable storage medium storing therein a program for causing a computer to function as: a task assigning unit that assigns a task of remotely controlling a vehicle to an operator who is selected from among a plurality of operators whose operating abilities are judged to be sufficient by newest evaluation results that are stored in a storage unit; an evaluation acquiring unit that acquires the evaluation result of the operational capability of the selected operator, in response to the selected operator performing the task that is assigned by the task assigning unit using a remote control unit that causes the vehicle to travel in response to remote control by the operator; and a storage control unit that performs control to store the newest evaluation result acquired by the evaluation acquiring unit in the storage unit.

In the non-transitory computer-readable storage medium, the evaluation acquiring unit may acquire, using a simulator unit that performs a simulation that causes the vehicle to travel in a virtual environment in response to operation by the operator, a new evaluation result of operational capability of: an operator whose operational capability is judged to be insufficient by the newest evaluation results; or an operator whose new evaluation result of operational capability has not been acquired for an amount of time prescribed in advance or longer.

A fourth exemplary embodiment of the present disclosure provides a non-transitory computer-readable storage medium storing therein a program for causing a computer to provide functions of: a task assigning unit that assigns a task of remotely controlling a vehicle to an operator who is selected from among a plurality of operators whose operating abilities are judged to be sufficient by newest evaluation results that are stored in a storage unit; an evaluation acquiring unit that acquires the evaluation result of the operational capability of the selected operator, in response to the selected operator performing the task that is assigned by the task assigning unit, using a remote control unit that causes the vehicle to travel in response to remote control by the operator, and acquires the evaluation result of the operational capability of the operator who performs a simulation, when the operator performs the simulation using a simulator unit that performs a simulation that that causes the vehicle to travel in a virtual environment in response to operation by the operator; and a storage control unit that performs control to store the newest evaluation result acquired by the evaluation acquiring unit in the storage unit.

A fifth exemplary embodiment of the present disclosure provides a remote assistance method including: prohibiting assignment of a task to an operator whose operational capability is judged to be insufficient by newest evaluation results that are stored in a storage unit, and assigning a task of remotely controlling a vehicle to an operator who is selected from among a plurality of operators whose operating abilities are judged to be sufficient by the newest evaluation results; acquiring the evaluation result of the operational capability of the selected operator, in response to the selected operator performing the assigned task using a remote control unit that causes the vehicle to travel in response to remote control by the operator; and performing control to store the newest evaluation result acquired by the evaluation acquiring unit in the storage unit.

The remote assistance method may further comprises acquiring, using a simulator unit that performs a simulation that causes the vehicle to travel in a virtual environment in response to operation by the operator, a new evaluation result of operational capability of: an operator whose operational capability is judged to be insufficient by the newest evaluation results; or an operator whose new evaluation result of operational capability has not been acquired for an amount of time prescribed in advance or longer.

As a result of the technology of the disclosure, a task of remotely controlling a vehicle can be assigned to an operator whose operational capability is guaranteed.

The above-described exemplary embodiments of the present disclosure will be further clarified through the detailed description below, with reference to the accompanying drawings.

An example of an embodiment for carrying out a technology of the present disclosure will hereinafter be described in detail with reference to the drawings.

### First Embodiment

### (Remote Assistance System)

A remote assistance system of the present disclosure is a system that remotely assists an autonomous driving vehicle (referred to, hereafter, as a “vehicle”) that autonomously travels. Here, remote assistance refers to an operator monitoring a state of the vehicle from a remote location and responding to a request for remote assistance from the vehicle. Response by the operator includes, in addition to the operator remotely controlling the vehicle, responding to a passenger of the vehicle. In addition, remote control includes remote driving in which the operator performs a driving operation of the vehicle and remote instruction in which the operator issues a direct traveling instruction to the vehicle. As the traveling instruction, permission to pass, permission to change traffic lanes, and the like can be given.

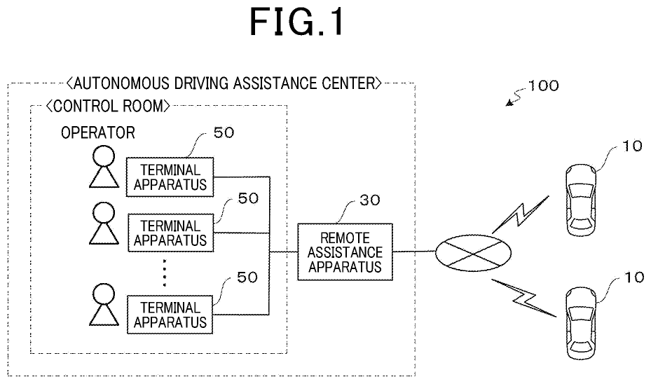

As shown in FIG. 1, a remote assistance system 100 includes a single or a plurality of vehicles 10, a remote assistance apparatus 30 that is set in an autonomous driving assistance center, and a single or a plurality of terminal apparatuses 50 that are each operated by an operator. The terminal apparatus 50 is set in a control room. The remote assistance apparatus 30 performs wireless communication with the vehicle 10. In addition, the remote assistance apparatus 30 performs wireless or wired communication with the terminal apparatus 50. Here, numbers of the vehicle 10 and the terminal apparatuses 50 are not limited to those shown in the drawings.

According to the present embodiment, a plurality of operators work in the control room in which the terminal apparatus 50 is set. Each of the plurality of operators operates a single terminal apparatus 50 that is assigned to the operator. Therefore, in the control room, a number of terminal apparatuses 50 that corresponds to the plurality of operators are in operation. Here, in the example in the drawing, the control room is arranged inside the autonomous driving assistance center. However, the control room may be arranged outside the autonomous driving assistance center.

The vehicle 10 is an autonomous driving vehicle that is capable of autonomously traveling based on a traveling plan that is generated by the own vehicle. The vehicle 10 provides a function for generating the traveling plan that includes a traveling route to a destination based on information on the destination, and a function for controlling driving, steering, and braking of the own vehicle such as to autonomously travel based on the traveling plan. The vehicle 10 requests remote assistance from the remote assistance apparatus 30 when assistance from the operator is required.

The remote assistance apparatus 30 periodically communicates with the vehicle 10 and monitors the state of the vehicle. The remote assistance apparatus 30 receives the request for remote assistance from the vehicle 10. Hereafter, the received request or a process that is related to the request is referred to as a “task.” The remote assistance apparatus 30 selects a single operator from among the plurality of operators and assigns the task of remotely assisting the vehicle 10 to the selected operator. The selected operator performs the assigned task by operating the corresponding terminal apparatus 50.

### (Electrical Configuration of Each Section)

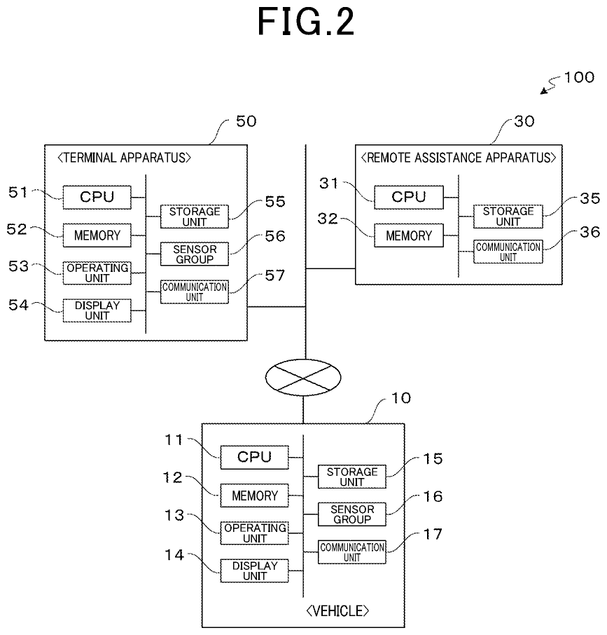

Next, an electrical configuration of each section of the remote assistance system will be described with reference to FIG. 2.

### —Vehicle—

The vehicle 10 may include a Central Processing Unit (CPU) 11, a memory 12, an operating unit 13, a display unit 14, a storage unit 15, a sensor group 16, and a communication unit 17.

The CPU 11 is an example of a processor. The processor herein refers to a processor in a broad sense, and includes a general-purpose processor (such as a CPU) and a dedicated processor (such as a Graphics Processing Unit [GPU], an Application Specific Integrated Circuit [ASIC], a Field Programmable Gate Array [FPGA], or a programmable logic device). The memory 12 is configured by a Read Only memory (ROM), a Random Access Memory (RAM), or the like.

For example, a Hard Disk Drive (HDD), a Solid State Drive (SSD), a flash memory, or the like may be used as the storage unit 15. The storage unit 15 stores therein an autonomous driving control program for performing control of autonomous driving and a remote controlled program for receiving remote control. In addition, the storage unit 15 stores therein map information that is required to generate the traveling plan for autonomous driving.

For example, the autonomous driving control program and the remote controlled program may be installed in the vehicle 10 in advance. In addition, the autonomous driving control program and the remote controlled program may be stored and distributed in a non-transitory, tangible storage medium, or distributed through communication and installed in the vehicle 10.

Here, as an example of the non-transitory, tangible storage medium, a semiconductor memory, a Compact Disc Read Only Memory (CD-ROM, a magneto-optical disk, an HDD, a Digital Versatile Disc Read Only Memory (DVD-ROM), a flash memory, a memory card, and the like are assumed.

The sensor group 16 is configured by various types of sensors. The sensor group 16 includes a plurality of cameras that capture images of a vicinity of the vehicle, and a millimeter-wave radar or a Light Detection and Ranging/Laser Imaging Detection and Ranging (LIDAR) that detects obstacles in the vicinity of the vehicle. A distance to the obstacle is acquired by the millimeter-wave radar or the LIDAR. In addition, the sensor group 16 may include a Global Positioning System (GPS) receiver. A current position of the own vehicle and a current time are acquired by the GPS receiver.

The operating unit 13 is an interface for receiving operation input. For example, a Liquid Crystal Display (LCD), an organic Electro Luminescence (EL) display, or the like may be used as the display unit 14. The display unit 14 may be integrally provided with a touch panel. The communication unit 17 is a communication interface for communicating with an external apparatus.

Here, although not shown, for example, the vehicle 10 may include traveling apparatuses that are required for autonomous driving, such as electric power steering, electronically controlled brakes, and an electronically controlled throttle. The vehicle 10 performs autonomous driving by controlling these traveling apparatuses.

In addition, because the vehicle 10 to be remotely assisted is an autonomous driving vehicle, electrical configurations of the autonomous driving vehicle are described above. Other vehicles that travel in the vicinity of the vehicle 10 include manually driven vehicles. For example, the manually driven vehicle does not include configurations that are only used for autonomous driving control, such as the autonomous driving control program. However, other electrical configurations are identical to those of the autonomous driving vehicle. Therefore, descriptions thereof are omitted. The manually driven vehicle is a so-called connected car. That is, although the manually driven vehicle is not to be remotely controlled, the manually driven vehicle is communicably connected to the remote assistance apparatus 30 by the communication unit 17 and exchanges various types of information with the remote assistance apparatus 30.

### —Remote Assistance Apparatus—

For example, the remote assistance apparatus 30 may be configured by a general-purpose computer apparatus, such as a server computer or a Personal Computer (PC). The remote assistance apparatus 30 may include a CPU 31, a memory 32, a storage unit 35, and a communication unit 36.

The CPU 31 is an example of a processor. The processor herein refers to a processor in a broad sense, as described above, and includes a general-purpose processor and a dedicated processor. The memory 32 is configured by a ROM, a RAM, or the like.

For example, an HDD, an SSD, a flash memory, or the like may be used as the storage unit 35. The storage unit 35 stores therein a remote assistance program for performing remote assistance for the vehicle.

For example, the remote assistance program may be installed in advance in the remote assistance apparatus 30. In addition, the remote assistance program may be stored and distributed in a non-transitory, tangible storage medium, or distributed through communication and installed in the remote assistance apparatus 30 as appropriate.

The communication unit 36 is a communication interface for communicating with an external apparatus.

### —Terminal Apparatus—

The terminal apparatus 50 may include a CPU 51, a memory 52, an operating unit 53, a display unit 54, a storage unit 55, a sensor group 56, and a communication unit 57.

The CPU 51 is an example of a processor. The processor herein refers to a processor in a broad sense, as described above, and includes a general-purpose processor and a dedicated processor. The memory 52 is configured by a ROM, a RAM, or the like.

For example, an HDD, an SSD, a flash memory, or the like may be used as the storage unit 55. The storage unit 55 stores therein a remote control program for enabling the operator to perform remote control of the vehicle. For example, the operator-side remote control program may be installed in the terminal apparatus 50 in advance. In addition, the operator-side remote control program may be stored and distributed in a non-transitory, tangible storage medium, or distributed through communication and installed in the terminal apparatus 50.

The sensor group 56 includes a biosensor that detects a biological response of the operator. As the biological response, heart rate, body temperature, posture, body movement, blinking, brain waves, and the like can be given.

The operating unit 53 is an interface for receiving operation input. For example, an LCD, an organic EL display, or the like may be used as the display unit 54. The display unit 54 may be integrally provided with a touch panel. The communication unit 57 is a communication interface for communicating with an external apparatus.

### (Functional Configuration of Each Section)

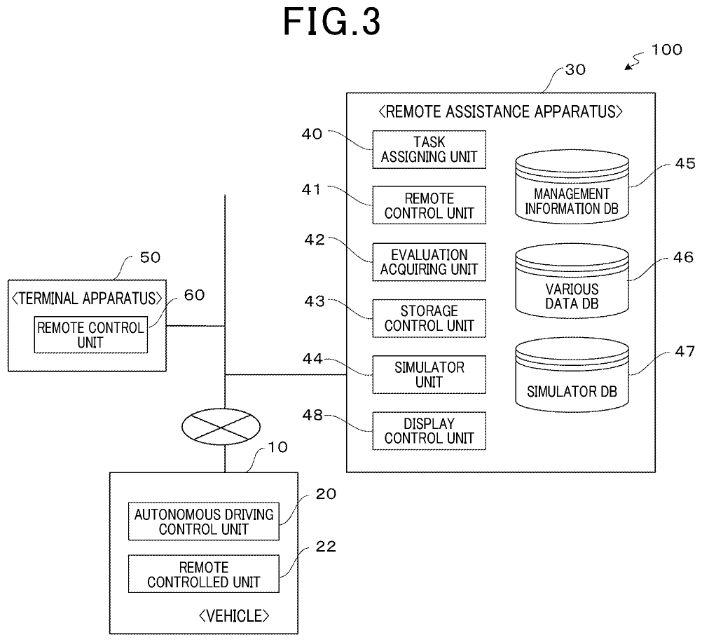

Next, functional configurations of the remote assistance system will be described with reference to FIG. 2 and FIG. 3.

The vehicle 10 may include an autonomous driving control unit 20 and a remote controlled unit 22. As a result of the CPU 11 of the vehicle 10 running the autonomous driving control program and the remote controlled program, a computer functions as the autonomous driving control unit 20 or the remote controlled unit 22.

The remote assistance apparatus 30 may include a task assigning unit 40, a remote controlling unit 41, an evaluation acquiring unit 42, a storage control unit 43, a simulator unit 44, a display control unit 48, a management information database (abbreviated, hereafter, to “DB”) 45, a various data DB 46, and a simulator DB 47.

As a result of the CPU 31 of the remote assistance apparatus 30 running the remote assistance program, a computer functions as the task assigning unit 40, the remote control unit 41, the evaluation acquiring unit 42, the storage control unit 43, the simulator unit 44, and the display control unit 48. In addition, for example, the management information DB 45, the various data DB 46, and the simulator DB 47 may be stored in the storage unit 35 of the remote assistance apparatus 30.

The terminal apparatus 50 may include a remote control unit 60. As a result of the CPU 51 of the terminal apparatus 50 running the remote assistance program on the operator side, a computer functions as the remote control unit 60.

Operations of each section will be described below, mainly focusing on the remote assistance apparatus 30.

### —Assignment of Tasks—

When a request for remote assistance is received from the vehicle 10, the task assigning unit 40 assigns the task of remotely assisting the vehicle 10 to an operator based on content of the assistance.

A management table that manages operator information is stored in the management information DB 45. The operator information includes a newest evaluation result related to an operational capability of the operator.

When the request for remote assistance is received from the vehicle 10, the task assigning unit 40 selects a single operator from among a plurality of operators whose operating abilities are judged to be sufficient (affirmed) based on the newest evaluation results. Then, the task assigning unit 40 assigns the task of remotely controlling the vehicle 10 to the selected operator.

### —Remote Control of the Vehicle—

The remote control unit 41 causes the operator to remotely operate the vehicle 10. The selected operator operates the corresponding terminal apparatus 50 and performs the assigned task.

The remote controlled unit 22 of the vehicle 10 transmits, to the remote assistance apparatus 30, information that indicates a vehicle state, such as an image of a vicinity of the vehicle 10 that is acquired by the sensor group 15 of the vehicle 10. The information that indicates the vehicle state is stored in the various data DB 46.

The remote control unit 41 generates data for a screen that is displayed to the operator using the information that indicates the vehicle state of the vehicle 10 and transmits the generated data to the terminal apparatus 50 that is operated by the selected operator. The remote control unit 60 of the terminal apparatus 50 displays the received screen in the display unit 54 and causes the selected operator to perform a driving operation or issue a traveling instruction. The screen that is displayed to the operator, that is, image information is stored in the various data DB 46.

The remote control unit 41 generates control information to remotely control the vehicle 10 based on an operation by the operator that is received by the operating unit 53 of the terminal apparatus 50 and transmits the generated control information to the vehicle 10. The remote controlled unit 22 of the vehicle 10 controls the operation of the vehicle 10 based on the received control information.

Various types of information related to the operation by the operator are transmitted from the terminal apparatus 50 that is operated by the operator to the remote assistance apparatus 30. In addition, traffic participants, such as the vehicle 10 to be controlled, other vehicles that are traveling in the vicinity of the vehicle 10, and occupants of the vehicle 10 and the other vehicles, are affected by the remote control by the operator. Various types of information related to the operation by the operator are transmitted to the remote assistance apparatus 30 from these traffic participants as well. The information received by the remote assistance apparatus 30 are stored in the various data DB 46.

### —Simulation—

The simulator unit 44 performs a simulation that causes the vehicle to travel in a virtual environment in response to operation by the operator, in an inspection to enable the operator to return to duty.

The simulator unit 44 acquires an image to be used in the simulation from the simulator DB 47. The simulator unit 44 transmits the acquired image to the terminal apparatus 50 that is operated by the operator who is subject to inspection. The remote control unit 60 of the terminal apparatus 50 displays the received image in the display unit 54 and causes the operator to perform an operation that simulates remote driving or remote instruction.

The various types of information related to the operation by the operator are transmitted to the remote assistance apparatus 30 from the terminal apparatus 50 that is operated by the operator. The information received by the remote assistance apparatus 30 is stored in the various data DB 46.

### —Acquisition of Evaluation—

The evaluation acquiring unit 42 acquires an evaluation result related to the operational capability of the operator when the operator performs a task. In addition, the evaluation acquiring unit 42 acquires an evaluation result related to the operational capability of the operator when the operator performs a simulation.

The evaluation acquiring unit 42 evaluates the operational capability of the operator based on the information that is stored in the various data DB 46 and acquires the evaluation result. The evaluation of the operational capability of the operator may be performed in the vehicle 10 to be controlled or another vehicle that is traveling in the vicinity of the vehicle 10. In this case, the evaluation acquiring unit 42 acquires the evaluation result from these vehicles.

### —Storage of Evaluation—

The storage control unit 43 stores the evaluation result acquired by the evaluation acquiring unit 42 in the management information DB 45 in association with the operator. Here, in the management information DB 45, for example, in addition to the newest evaluation result, all evaluation results that have been acquired over a fixed period, such as half a day or a single day, may be stored in association with the operator.

### —Display of the Evaluation Result—

The display control unit 48 causes the display unit 54 of the terminal apparatus 50 that is used by the operator to display various types of screens. For example, the display control unit 48 may cause the display unit 54 to display a screen that displays an evaluation result and a screen that includes an instructing unit that instructs start of a simulation.

Here, the example in which the remote assistance apparatus 30 includes the simulator unit 44, the management information DB 45, the various data DB 46, and the simulator DB 47 is described. However, these functional units may be provided outside the remote assistance apparatus 30.

### (Management of Operators)

Next, management of operators will be described.

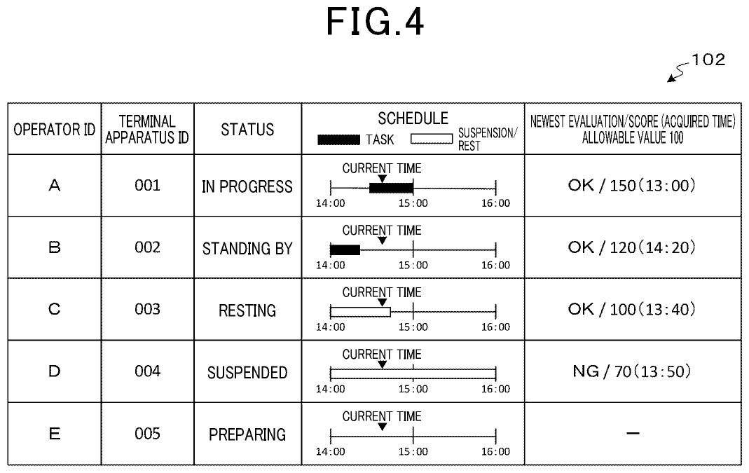

As shown in FIG. 4, identification information (ID) of the operators who work in the control room is registered in the management table 102. The management table 102 stores therein an ID of the terminal apparatus, a status, a schedule, and the newest evaluation result in association with the ID of the operator.

For example, the ID of the operator may be expressed by A, B, C, D, E and the like. For example, the ID of the terminal apparatus may be expressed by 001, 002, 003, 004, 005, and the like.

For example, the status of the operator may be expressed by preparing, standing by, in progress, suspended, resting, and the like. Each status expresses in a state shown in Table 1, below. The task herein is remote control. Here, definitions and classifications of the statuses are examples and may be modified as appropriate.

TABLE 1

| Status | Content |
|---|---|
| Preparing | Operator has started duties of the day but has not yet |
| | received evaluation. Assignment of a task to the |
| | operator is not possible. |
| Standing by | The operational capability is judged to be sufficient by the |
| | evaluation result. Assignment of a task to the operator is |
| | possible. |
| In progress | The operator is performing an assigned task. Assignment of |
| | another task to the operator is not possible. |
| Suspended | The operational capability is judged to be insufficient by |
| | evaluation result. Assignment of a task to the operator is |
| | not possible. |
| Resting | The operator is resting. Assignment of a task to the operator |
| | is not possible. |

According to the present embodiment, every time the operator performs a task, an evaluation related to the operational capability of the operator is performed. The operator whose operational capability is judged to be sufficient (affirmed) by the evaluation result has the status set to “standing by.” Meanwhile, the operator whose operational capability is judged to be insufficient (denied) by the evaluation result has the status changed to “suspended.” Assignment of a task to the operator whose status is “suspended” is prohibited.

In addition, the operator who has just started duties of the day has not yet received evaluation. Therefore, the status is set to “preparing.” Assignment of a task to the operator whose status is “preparing” is also prohibited.

Furthermore, when the operator is resting, the status is changed to “resting.” Assignment of a task is not performed to the operator whose status is “resting.” When a rest period ends within a predetermined amount of time without the rest period being extended, the status returns to “standing by.” Meanwhile, when the rest period is extended, the status is changed to “suspended.” A reason for this is, when a period during which an evaluation is not performed becomes longer, reliability of the evaluation results that are already acquired decreases.

The operator whose status is “suspended” or “preparing” is subject to inspection to return to duty. The operator whose operational capability is judged to be sufficient by an inspection result has the status returned to “standing by,” that is, is able to return to duty.

The schedule of the operator is used to confirm availability of the operator and indicates a time period during which assignment of a task is not possible. For example, as indicated by a black band, while a task is being performed, assignment of a task may be impossible from a start time of the task to an expected end time. As indicated by a white band, when the status is suspended or resting, assignment of a task is not possible from a start time of the suspension or rest until an expected end time.

The newest evaluation result is the newest evaluation result among evaluation results that are related to the operational capability of the operator. The evaluation result is an evaluation result when the operator performs a task or an evaluation result when the operator performs a simulation.

The evaluation result may be expressed by capability/incapability of performing duties, such as “capable of performing duties” or “incapable of performing duties,” or may be expressed by a score that indicates the operational capability. In FIG. 4, “capable of performing duties” is displayed as OK and “incapable of performing duties” is displayed as NG. In addition, the evaluation result may be expressed by both capability/incapability of performing duties and the score. Time at which the evaluation result is acquired may be associated with the evaluation result.

The score that indicates the operational capability indicates that the operational capability of the operator is higher as a value thereof increases. An allowable value is set in advance for the score.

In the management table, when the evaluation result is OK (that is, capable of performing duties) or when the score is equal to or greater than the allowable value, the evaluation result is positive and the operational capability of the operator is judged to be sufficient. Meanwhile, when the evaluation result is NG (that is, incapable of performing duties) or when the score is less than the allowable value, the evaluation result is negative and the operating capability of the operator is judged to be insufficient.

### (Remote Assistance Process)

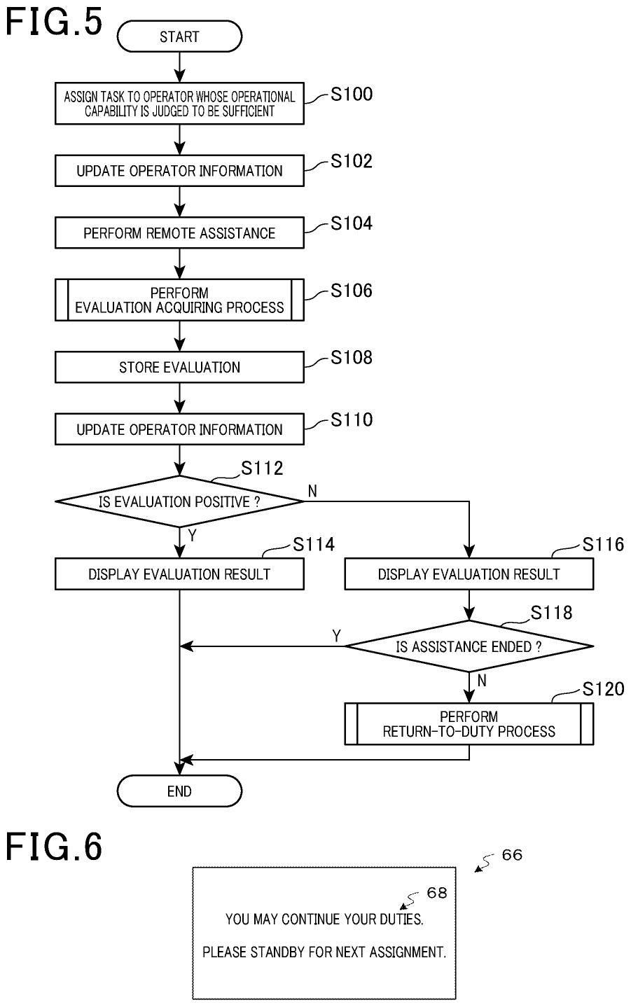

Next, the remote assistance program for performing remote assistance for the vehicle will be described with reference to FIG. 5. The remote assistance program is run by the CPU 31 of the remote assistance apparatus 30 when a task is received from the vehicle 10 (see FIG. 2). Here, the task is remote control.

First, at step S100, the CPU 31 references the management table shown in FIG. 4 and selects a single operator whose schedule is free from among the plurality of operators whose evaluation results are positive. Then, the CPU 31 assigns the task to the selected operator.

Next, at step S102, the CPU 31 changes the status of the operator to whom the task is assigned from “standing by” to “in progress” and updates the schedule of the operator.

Next, at step S104, the CPU 31 causes the operator to whom the task is assigned to remotely operate the vehicle 10. The operator operates the corresponding terminal apparatus 50 and performs the assigned task.

Next, at step S106, the CPU 31 performs an “evaluation acquiring process” to acquire the evaluation result related to the operational capability of the operator when the operator performs the task.

Next, at step S108, the CPU 31 stores the evaluation result acquired at step S106 in the management information DB 45 in association with the operator.

Next, at step S110, the CPU 31 changes the status of the operator based on the evaluation result acquired at step S106, and updates the schedule and the newest evaluation result of the operator.

Next, at step S112, the CPU 31 determines whether the evaluation result acquired at step S106 is a positive evaluation result. When the evaluation result is a positive evaluation result, the CPU 31 proceeds to step S114. When the evaluation result is a negative evaluation result, the CPU 31 proceeds to step S116.

Next, at step S114, the CPU 31 generates data of a screen (such as a screen 66 in FIG. 6) for displaying the positive evaluation result to the operator and transmits the data to the terminal apparatus 50. The CPU 31 causes the display unit 54 of the terminal apparatus 50 to display the screen and ends the program.

As shown in FIG. 6, on the screen 66, a message 68 that communicates the positive evaluation result and prompts standby, such as “You may continue your duties. Please standby for next assignment,” is displayed.

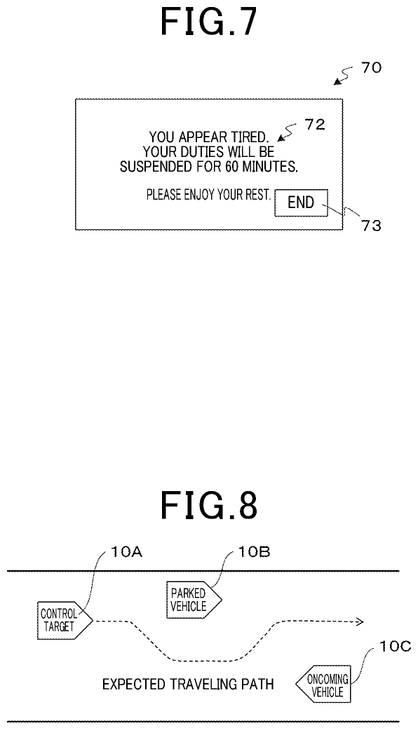

Meanwhile, at step S116, the CPU 31 generates data of a screen (such as a screen 70 in FIG. 7) for displaying the negative evaluation result to the operator and transmits the data to the terminal apparatus 50. The CPU 31 causes the display unit 54 of the terminal apparatus 50 to display the screen.

As shown in FIG. 7, a message 72 that communicates the negative evaluation result and prompts rest, such as “You appear tired. Your duties are suspended for 60 minutes. Please enjoy your rest,” and a button 73 that instructs end of providing assistance are displayed. The operator who wishes to end assistance, such as leave work due to ill health, instructs end of providing assistance by pressing the button 73.

Next, at step S118, the CPU 31 determines whether the end of providing assistance is instructed. When the end of providing assistance is instructed, the program is ended. Meanwhile, when the end of providing assistance is not instructed, the CPU 31 proceeds to step S120.

Next, at step S120, the CPU 31 performs a return-to-duty process for assisting the return-to-duty of the operator and ends the program. The operator whose status is “suspended” is subject to inspection to return to duty. When the operational capability of the operator is judged to be sufficient by the inspection result, the status is changed to “standing by” and the operator can return to duty. The return-to-duty process is described according to a sixth embodiment, described hereafter.

### —Evaluation Acquiring Process—

Next, the evaluation acquiring process performed at step S106 in FIG. 5 will be described.

According to the first embodiment, the operational capability of the operator is evaluated based on effects the operation by the operator has on an oncoming vehicle.

As shown in FIG. 8, in this example, a vehicle 10A causes an operator who is in a remote location to determine whether avoidance of a parked vehicle 10B that is an obstacle can be performed. Hereafter, the vehicle 10A that is remotely controlled by the operator is referred to as a control target vehicle 10A.

An expected traveling path of the control target vehicle 109 is shown by a dotted line. As a result of the operator issuing a permission to start to the control target vehicle 10, the control target vehicle 10A travels path that circumvents the parked vehicle 10B while running into the oncoming traffic lane. The oncoming vehicle 10C of the control target vehicle 10A stops and waits until the control target vehicle 10 passes. The control target vehicle 10A, the parked vehicle 10B, and the oncoming vehicle 10C are each an aspect of the vehicle 10.

While the operator is performing the task, information that indicates the vehicle state that is acquired by the sensor group 16 of the control target vehicle 10A (such as information related to an inter-vehicle distance to an oncoming vehicle that is acquired by the LIDAR) is transmitted from the control target vehicle 10A to the remote assistance apparatus 30 and stored in the various data DB 46 (see FIG. 2). The CPU 31 of the remote assistance apparatus 30 acquires the required information from the various data DB 46 and evaluates the operational capability of the operator (see FIG. 2 and FIG. 3).

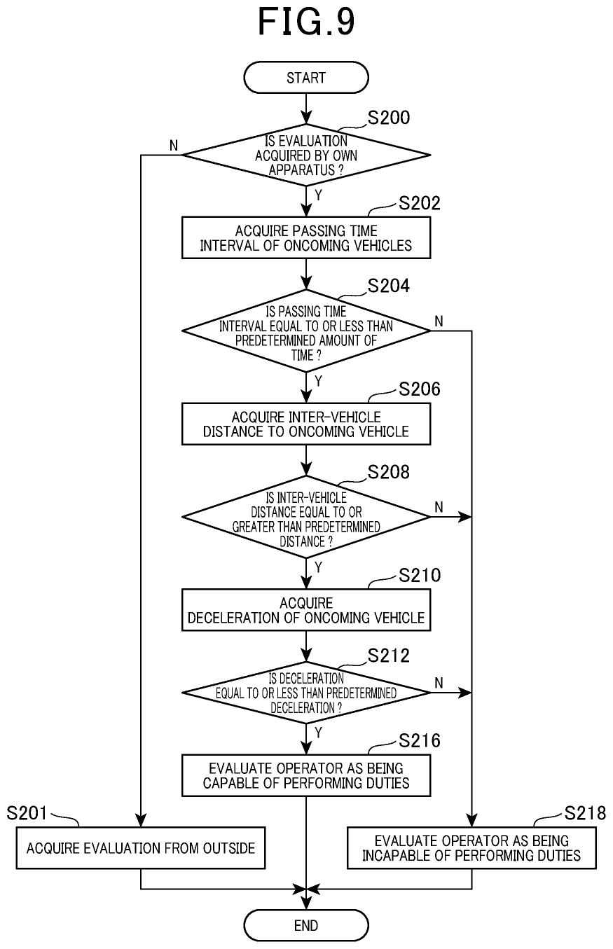

As shown in FIG. 9, in the evaluation acquiring process, first, at step S200, the CPU 31 determines whether the evaluation result is acquired by the own apparatus. When the evaluation result is acquired by the own apparatus, the CPU 31 proceeds to step S202. When the evaluation result is not acquired by the own apparatus, the CPU 31 proceeds to step S201. As step S201, the CPU 31 acquires the evaluation result from outside and ends a routine for the evaluation acquiring process.

Next, at step S202, the CPU 31 acquires a passing time interval of the oncoming vehicle. The passing time interval of the oncoming vehicle refers to a time interval from when a leading oncoming vehicle passes the control target vehicle until a next oncoming vehicle passes the control target vehicle.

Next, at step S204, the CPU 31 determines whether the passing time interval of the oncoming vehicles is equal to or less than a predetermined amount of time. When the passing time interval is equal to or less than the predetermined amount of time, the CPU 31 proceeds to step S206.

Meanwhile, when the passing time interval exceeds the predetermined amount of time, the CPU 31 proceeds to step S218. At step S218, the CPU 31 determines that the operator is incapable of performing duties and ends the routine for the evaluation acquiring process. When the passing time interval exceeds the predetermined amount of time, the operator has been unable to instruct start of traveling regardless of a sufficient inter-vehicle distance being present between the leading oncoming vehicle and the next oncoming vehicle. Therefore, judgment of the operator can be determined to be inappropriate.

Next, at step S206, the CPU 31 acquires an inter-vehicle distance between the control target vehicle and the oncoming vehicle while the control target vehicle avoids the parked vehicle and returns to an own traffic lane. Next, at step S208, the CPU 31 determines whether the inter-vehicle distance to the oncoming vehicle is equal to or greater than a predetermined distance. When the inter-vehicle distance between the control target vehicle and the oncoming vehicle is equal to or greater than a predetermined distance, the CPU 31 proceeds to step S210.

Meanwhile, when the inter-vehicle distance to the oncoming vehicle is less than the predetermined distance, the CPU 31 proceeds to step S218. At step S218, the CPU 31 determines that the operator is incapable of performing duties and ends the routine for the evaluation acquiring process. A determination can be made that, as a result of the operation for avoiding the obstacle being performed, the distance between the control target vehicle and the oncoming vehicle has become too close.

Next, at step S210, the CPU 31 acquires deceleration of the oncoming vehicle. Here, a magnitude of the deceleration is expressed by an absolute value thereof. Next, at step S212, the CPU 31 determines whether the deceleration of the oncoming vehicle is equal to or less than a predetermined deceleration. When the deceleration of the oncoming vehicle is equal to or less than the predetermined deceleration, the CPU 31 proceeds to step S216.

Meanwhile, when the deceleration of the oncoming vehicle is greater than the predetermined deceleration, the CPU 31 proceeds to step S218. At step S218, the CPU 31 determines that the operator is incapable of performing duties and ends the routine for the evaluation acquiring process. A determination is made that, as a result of the control target vehicle entering an oncoming traffic lane, the oncoming vehicle has decelerated more than a predetermined value to avoid collision.

Next, at step S216, the CPU 31 determines that the operator is capable of performing duties and ends the routine for the evaluation acquiring process.

Here, determination items are examples. The determination items may be added, deleted, or modified according to a main purpose of the present embodiment. In addition, when evaluation of the operational capability of the operator is performed in the control target vehicle or the oncoming vehicle, the CPU 11 of the vehicle 10 acquires the evaluation result by performing the processes at step S202 to step S218 in FIG. 9. In this case, at above-described step S201, the CPU 31 of the remote assistance apparatus 30 acquires the evaluation result that is capable of performing duties or incapable of performing duties from the vehicle 10.

### —Modifications—

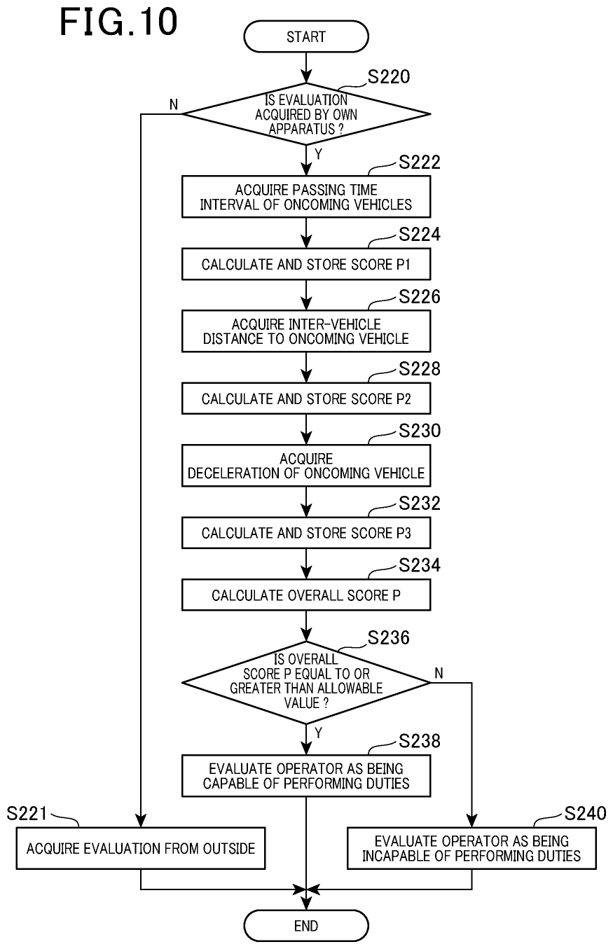

In addition, in the example of the evaluation acquiring process described above, an example in which the evaluation result that is expressed by capability/incapability of performing duties is described. However, only a score may be determined. Alternatively, both capability/incapability of performing duties and a score may be determined. In an example shown in FIG. 10, both capability/incapability of performing duties and a score are determined.

In an evaluation acquiring process shown in FIG. 10, first, at step S220, the CPU 31 determines whether the evaluation result is acquired by the own apparatus. When the evaluation result is acquired by the own apparatus, the CPU 31 proceeds to step S222. When the evaluation result is not acquired by the own apparatus, the CPU 31 proceeds to step S221. At step S221, the CPU 31 acquires the evaluation result from outside and ends the routine for the evaluation acquiring process.

Next, at step S222, the CPU 31 acquires the passing time interval of the oncoming vehicles. Next, at step S224, the CPU 31 calculates and stores a score P1.

Then, at step S226, the CPU 41 acquires the inter-vehicle distance between the control target vehicle and the oncoming vehicle. Next, at step S228, the CPU 31 calculates and stores a score P2.

Next, at step S230, the CPU 31 acquires the deceleration of the oncoming vehicle. Next, at step S232, the CPU 31 calculates and stores a score P3.

Next, at step S234, the CPU 31 calculates an overall score P using the score P1, the score P2, and the score P3. The determination items may be weighted rather than averaged. For example, the overall score may be a value that is obtained by the score P1, the score P2, and the score P3 being weighted and added together.

Next, at step S236, the CPU 31 determines whether the overall score P is equal to or greater than an allowable value. When the overall score P is equal to or greater than the allowable value, the CPU 31 proceeds to step S238. At step S238, the CPU 31 determines that the operator is capable of performing duties and ends the routine for the evaluation acquiring process. Meanwhile, when the overall score P is less than the allowable value, the CPU 31 proceeds to step S240. At step S240, the CPU determines that the operator is incapable of performing duties and ends the routine for the evaluation acquiring process.

According to the first embodiment, evaluation of operational capability of each of the plurality of operators is performed in real time. When the task of remotely controlling the vehicle is assigned, the task is assigned to an operator whose operational capability is judged to be sufficient by the evaluation result. Therefore, the task can be assigned to the operator whose operational capability is guaranteed.

The task of remotely controlling the vehicle is not assigned to the operator whose operational capability is judged to be insufficient by the evaluation result. Therefore, erroneous operations and erroneous judgment caused by operator fatigue can be prevented.

The operational capability is objectively evaluated based on the effects the operation by the operator has on the vicinity. Therefore, latent decrease in operational capability of the operator can be detected in advance.

### Second Embodiment

According to a second embodiment, the operational capability of the operator is evaluated based on the effects the operation by the operator has on a passenger of the control target vehicle. Aside from steps in the evaluation acquiring process, configurations are identical to those according to the first embodiment. Descriptions of identical configurations are omitted. The evaluation acquiring process that is the difference will be described below.

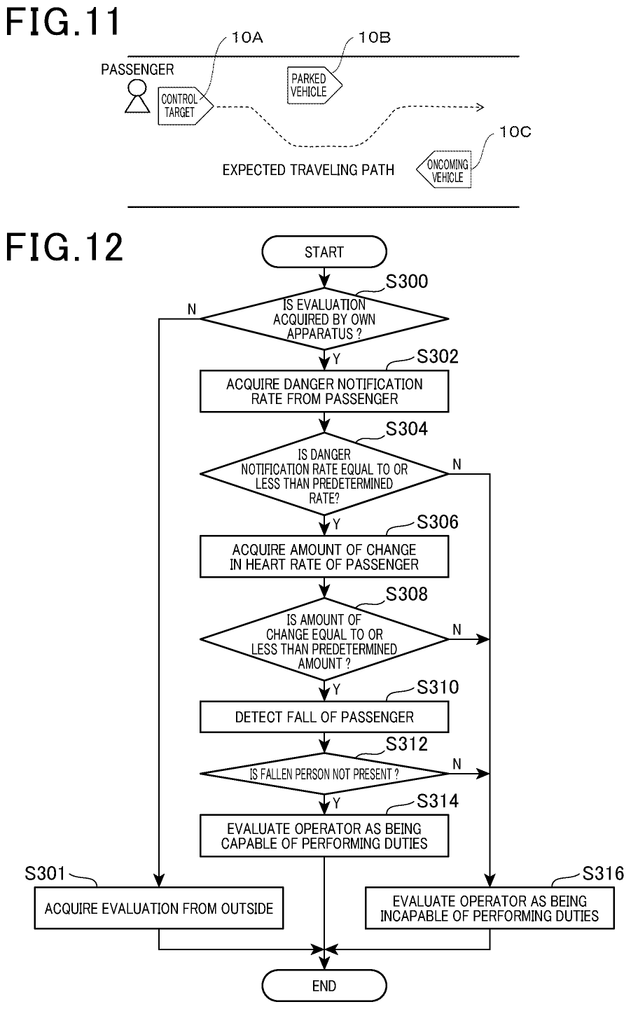

As shown in FIG. 11, a relationship among the control target vehicle 10A, the parked vehicle 10B, and the oncoming vehicle 10C is similar to that in the example shown in FIG. 8. However, a passenger is aboard the control target vehicle 10A. The passenger may be a plurality of people.

A sensor for detecting a passenger state is set in the control target vehicle 10A as the sensor group 16 (see FIG. 2 and FIG. 3). As the sensor that detects the passenger state, an in-cabin camera that captures an image of a cabin interior, a biosensor that detect a biological response of the passenger such as heart rate or brain waves, or the like is set. The biosensor is incorporated into a seat or the like. Images from the in-cabin camera are used to detect a fall of the passenger and the like. In addition, a danger notification button by which the passenger reports danger is set as a part of the operating unit 13 in the control target vehicle 10A (see FIG. 2 and FIG. 3).

Here, an example in which the passenger notifies the remote assistance apparatus 30 using the danger notification button that is set in the control target vehicle 10A is described. However, a mechanism for reporting danger is not limited to this example. For example, the mechanism for reporting danger may be provided as a danger notification application for a mobile apparatus such as a smartphone. In this case, the passenger directly notifies the remote assistance apparatus 30 using the danger notification application that is installed in the mobile apparatus. The danger notification button and the danger notification application both give notification of danger when a button is pressed, and record time and location using a clock and GPS.

While the operator is performing the task, information related to the passenger state that is acquired by the sensor group 16 of the control target vehicle 10A and a signal from the danger notification button are transmitted from the control target vehicle 10 to the remote assistance apparatus 30 and stored in the various data DB 46 (see FIG. 2). The CPU 31 of the remote assistance apparatus 30 acquires the required information from the various data DB 46 and evaluates the operational capability of the operator (see FIG. 2 and FIG. 3).

As shown in FIG. 12, in the evaluation acquiring process according to the second embodiment, first, at step S300, the CPU 31 determines whether the evaluation result is acquired by the own apparatus. When the evaluation result is acquired by the own apparatus, the CPU 31 proceeds to step S302. When the evaluation result is not acquired by the own apparatus, the CPU 31 proceeds to step S301. At step S301, the CPU 31 acquires the evaluation result from outside and ends the routine for the evaluation acquiring process.

Next, at step S302, the CPU 31 acquires a danger notification rate from the passenger. The danger notification rate is a rate at which the passenger onboard presses the danger notification button. For example, in a case in which ten passengers are present, when nine out of ten passengers press the danger notification button, the danger notification rate may be 90%. In addition, for example, when the passenger is one person, if the task is a ten-minute task, whether the danger notification button is pressed may be determined every minute. In this case, when the number of times that the danger notification button is pressed is nine times, the danger notification rate is 90%.

Next, at step S304, the CPU 31 determines whether the danger notification rate from the passenger is equal to or less than a predetermined rate. When the danger notification rate is equal to or less than the predetermined rate, the CPU 31 proceeds to step S306. Meanwhile, when the danger notification rate exceeds the predetermined rate, the CPU 31 proceeds to step S316. At step S316, the CPU 31 determines that the operator is incapable of performing duties and ends the routine for the evaluation acquiring process. A determination that the passenger feels danger towards the operation by the operator can be made.

Next, at step S306, the CPU 31 acquires an amount of change in the heart rate of the passenger. Next, at step S308, the CPU 31 determines whether the amount of change in the heart rate of the passenger is equal to or less than a predetermined amount. When the amount of change in the heart rate is equal to or less than the predetermined amount, the CPU 31 proceeds to step S310. Meanwhile, when the amount of change in the heart rate exceeds the predetermined amount, the CPU 31 proceeds to step S316. At step S316, the CPU 31 determines that the operator is incapable of performing duties and ends the routine for the evaluation acquiring process. A determination that the passenger feels danger towards the operation by the operator and the heart rate of the passenger has increased can be made.

Next, at step S310, the CPU 31 detects a fall of the passenger from the image from the in-cabin camera. Next, at step S312, the CPU 31 determines whether a fallen person is present. When a fallen person is not present, the CPU 31 proceeds to step S314. Meanwhile, when a fallen person is present, the CPU 31 proceeds to step S316. At step S316, the CPU 31 determines that the operator is incapable of performing duties and ends the routine for the evaluation acquiring process. A determination that the operation by the operator is poor and the passenger has fallen can be made.

Next, at step S314, the CPU 31 determines that the operator is capable of performing duties and ends the routine for the evaluation acquiring unit.

Here, the determination items are examples. The determination items may be added, deleted, or modified according to a main purpose of the second embodiment. The amount of change in the heart rate of the passenger may be an example. Whether the heart rate of the passenger is equal to or less than a predetermined value may be determined. In addition, instead of the fall of the passenger, “swaying” of the passenger may be detected. Instead of the danger notification rate, anxiety of the passenger may be determined. The image from the in-cabin camera may be used to detect “swaying” and may be used to estimate emotions, such as anxiety, from expressions of the passenger. In addition, when the evaluation of the operational capability of the operator is performed in the control target vehicle or the oncoming vehicle, the CPU 11 of the vehicle 10 acquires the evaluation result by performing the processes at step S302 to step S316 in FIG. 11. The CPU 31 of the remote assistance apparatus 30 acquires the evaluation result from the vehicle 10 at above-described step S301.

According to the second embodiment, in addition to the effects according to the first embodiment, an opinion of the passenger can also be reflected in the evaluation of the operational capability of the operator. Sensitivity to danger differs based on country and region. As a result of the opinion of the passenger being reflected in the evaluation, an evaluation that reflects circumstances of a traveling region can be achieved. In addition, this also leads to resolution of anxiety in the passenger towards remote control of the vehicle.

### Third Embodiment

According to a third embodiment, the operational capability of the operator is evaluated based on the effects the operation by the operator has on traffic participants, such as another vehicle that is traveling in the vicinity of the control target vehicle and an occupant of the other vehicle. Aside from steps in the evaluation acquiring process, configurations are identical to those according to the first embodiment. Descriptions of identical configurations are omitted. The evaluation acquiring process that is the difference will be described below.

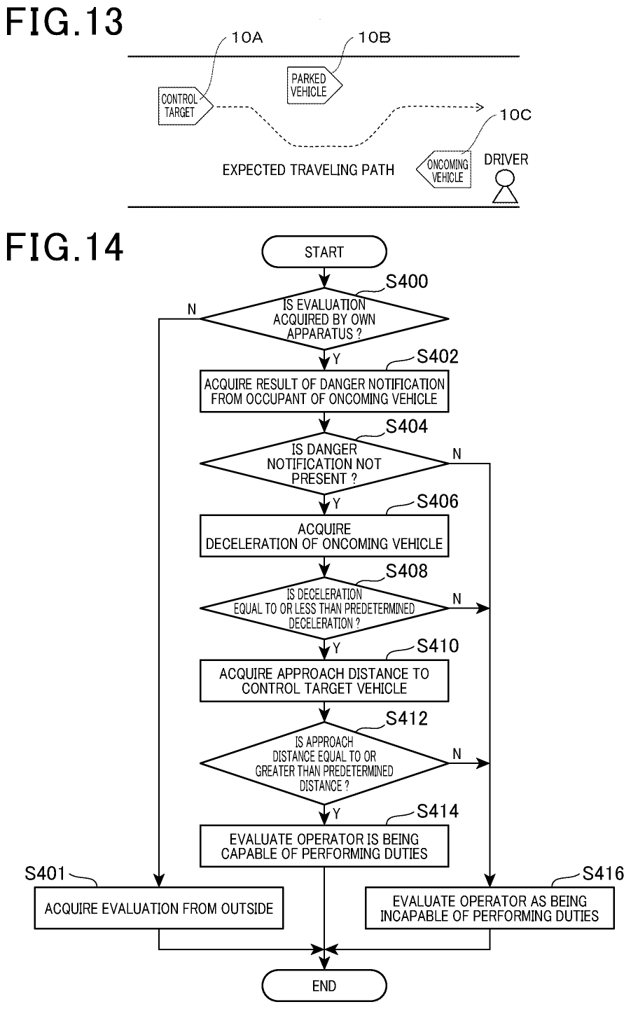

As shown in FIG. 13, the relationship among the control target vehicle 10A, the parked vehicle 10B, and the oncoming vehicle 10C is similar to that in the example shown in FIG. 8. However, the oncoming vehicle 10C is a manual vehicle in which a driver is onboard. In addition, a passenger may be aboard the oncoming vehicle 10C.

The danger notification button by which the occupant (such as a driver or a passenger) reports danger is set in the oncoming vehicle 10C. Here, in a manner similar to that according to the second embodiment, the mechanism for reporting danger may be provided as the danger notification application for a mobile apparatus.

While the operator is performing the task, information related to a vehicle state and an occupant state that is acquired by the sensor group 16 of the oncoming vehicle 10C is transmitted from the oncoming vehicle 10C to the remote assistance apparatus 30 and stored in the various data DB 46 (see FIG. 2). The CPU 31 of the remote assistance apparatus 30 acquires the required information from the various data DB 46 and evaluates the operational capability of the operator (see FIG. 2 and FIG. 3).

As shown in FIG. 14, in the evaluation acquiring process according to the third embodiment, first, at step S400, the CPU 31 determines whether the evaluation result is acquired by the own apparatus. When the evaluation result is acquired by the own apparatus, the CPU 31 proceeds to step S402. When the evaluation result is not acquired by the own apparatus, the CPU 31 proceeds to step S401. At step S401, the CPU 31 acquires the evaluation result from outside and ends the routine for the evaluation acquiring process.

Next, at step S402, the CPU 31 acquires a result of a danger notification from the occupant of the oncoming vehicle. Next, at step S404, the CPU 31 determines whether the danger notification from the occupant is not present. When the danger notification is not present, the CPU 31 proceeds to step S406. Meanwhile when the danger notification is present, the CPU 31 proceeds to step S416. At step S416, the CPU 41 determines that the operator is incapable of performing duties and ends the routine for the evaluation acquiring process. A determination that the occupant feels danger towards the operation by the operator can be made.

In addition, the result of the danger notification may be provided by a danger level in multiple levels. As a degree of danger increases, a value of the danger level increases. For example, a danger notification button may be provided for each danger level. The occupant of the oncoming vehicle presses a button that corresponds to the danger level experienced by the occupant themselves and gives notification of the danger level. In this case, when the danger level is equal to or less than a predetermined level, the danger notification is determined to not be present. In addition, when the danger level is greater than the predetermined level, the danger notification is determined to be present.

Next, at step S406, the CPU 31 acquires the deceleration of the oncoming vehicle. Next, at step S408, the CPU 31 determines whether the deceleration of the oncoming vehicle is equal to or less than a predetermined deceleration. When the deceleration of the oncoming vehicle is equal to or less than the predetermined deceleration, the CPU 31 proceeds to step S410. Meanwhile, when the deceleration of the oncoming vehicle exceeds the predetermined deceleration, the CPU 31 proceeds to step S416. At step S416, the CPU 31 determines that the operator is incapable of performing duties and ends the routine for the evaluation acquiring process.

Next, at step S410, the CPU 31 acquires an approach distance to the control target vehicle. Next, at step S412, the CPU 31 determines whether the approach distance to the control target vehicle is equal to or greater than a predetermined distance. When the approach distance is equal to or greater than the predetermined distance, the CPU 31 proceeds to step S414. Meanwhile, when the approach distance is less than the predetermined distance, the CPU 31 proceeds to step S416. At step S416, the CPU 41 determines that the operator is incapable of performing duties and ends the routine for the evaluation acquiring process.

Next, at step S414, the CPU 31 determines that the operator is capable of performing duties and ends the routine for the evaluation acquiring process.

Here, the determination items are examples. The determination items may be added, deleted, or modified according to a main purpose of the third embodiment. In addition, when the evaluation of the operational capability of the operator is performed in the oncoming vehicle, the CPU 11 of the vehicle 10 acquires the evaluation result by performing the processes at step S402 to step S416 in FIG. 14. The CPU 31 of the remote assistance apparatus 30 acquires the evaluation result from the vehicle 10 at above-described step S401.

In addition, the traffic participants may include a bicycle and a pedestrian that is present in the vicinity of the control target vehicle. In this case, a rider of the bicycle or the pedestrian holds a mobile apparatus in which the danger notification application is installed and reports danger using the mobile apparatus.

According to the third embodiment, in addition to the effects according to the first embodiment, a measurement result from a surrounding vehicle and an opinion of occupant in the surrounding vehicle can be reflected in the evaluation of the operational capability of the operator. In a manner similar to that according to the second embodiment, an evaluation that reflects the circumstances of the traveling region can be achieved. This also leads to resolution of anxiety in the occupant of the surrounding vehicle towards remote control of the vehicle.

In addition to the effects according to the first embodiment, according to the third embodiment, the opinions of the traffic participants, such as an occupant of a surrounding vehicle, can be reflected in the evaluation of the operational capability of the operator.

### Fourth Embodiment

According to a fourth embodiment, the operational capability of the operator is evaluated based on an operating state by the operator. Aside from steps in the evaluation acquiring process, configurations are identical to those according to the first embodiment. Descriptions of identical configurations are omitted. The evaluation acquiring process that is the difference will be described below.

When the task is assigned to the operator, the remote assistance apparatus 30 measures a response time and a processing time of the operator for the assigned task. Here, the response time is an amount of time from the remote assistance apparatus 30 calling the operator until the operator responds. The measured response time and processing time are stored in the various data DB 46. The CPU 31 of the remote assistance apparatus 30 acquires the required information from the various data DB 46 and evaluates the operational capability of the operator (see FIG. 2 and FIG. 3).

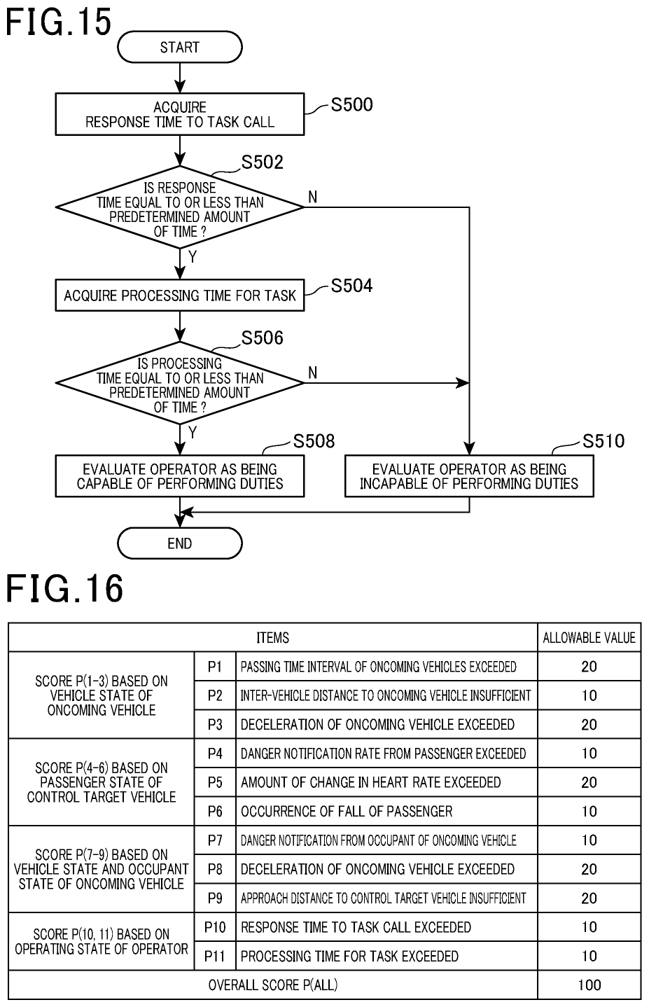

As shown in FIG. 15, in the evaluation acquiring process according to the fourth embodiment, first, at step S500, the CPU 31 acquires the response time of the operator to a task call. Next, at step S502, the CPU 31 determines whether the response time of the operator is equal to or less than a predetermined amount of time. When the response time is equal to or less than the predetermined amount of time, the CPU 31 proceeds to step S504. Meanwhile, when the response time exceeds the predetermined amount of time, the CPU 31 proceeds to step S510. At step S510, the CPU 31 determines that the operator is incapable of performing duties and ends the routine for the evaluation acquiring process.

Next, at step S504, the CPU 31 acquires the processing time for the task. Next, at step S506, the CPU 31 determines whether the processing time for the task is equal to or less than a predetermined amount of time. When the processing time for the task is equal to or less than the predetermined amount of time, the CPU 31 proceeds to step S508. Meanwhile, when the processing time for the task exceeds the predetermined amount of time, the CPU 31 proceeds to step S510. At step S510, the CPU 31 determines that the operator is incapable of performing duties and ends the routine for the evaluation acquiring process.

Next, at step S508, the CPU 31 determines that the operator is capable of performing duties and ends the routine for the evaluation acquiring process.

Here, the determination items are examples. The determination items may be added, deleted, or modified according to a main purpose of the fourth embodiment. To detect changes in a physical condition of the operator, biosensors that detects biological responses of the operator, such as heart rate and brain waves, are installed as the sensor group 56 in the terminal apparatus 50 (see FIG. 2 and FIG. 3). In the evaluation acquiring process shown in FIG. 15, the evaluation is performed based only on the operating state of the operator. For example, the operational capability of the operator may be evaluated taking into consideration the detection results of these biosensors. For example, when an increase in the heart rate or an abnormality in the brain waves is detected, the CPU 31 may determine that the operator is in ill health and is incapable of performing duties.

According to the fourth embodiment, in addition to the effects according to the first embodiment, data acquisition is facilitated. The evaluation of the operational capability of the operator can be performed by a simple calculation. Here, according to the fourth embodiment, unlike the first embodiment, the operational capability of the operator is evaluated based on the operating state of the operator rather than the effects the operation by the operator has on the vicinity. Both are identical in that the operational capability of the operator is objectively evaluated. Therefore, according to the fourth embodiment, latent decrease in the operational capability of the operator can be detected in advance.

### Fifth Embodiment

According to the first to fourth embodiments, the operational capability of the operator is evaluated from various perspectives. According to a fifth embodiment, an overall score is determined from the score of each determination item. Then, the operational capability of the operator is evaluated based on the obtained overall score. As described above, the score expresses the operational capability of the operator in points. Aside from steps in the evaluation acquiring process, configurations are identical to those according to the first embodiment. Descriptions of identical configurations are omitted. The evaluation acquiring process that is the difference will be described below.

### (Calculation Example of Overall Score P(ALL))

First, a calculation example of the overall score will be described.

When an N number of determination items are present, an overall score P(ALL) is calculated from scores P₁ to P_{N} that correspond to the N number of determination items and weights w₁ to w_{N} of the determination items.

An example of a calculation formula for the overall score P(ALL) is shown in expression (1), below. Respective values of the weights w₁ to w_{N} can be arbitrarily set.

P(ALL)=w₁P₁+w₂P₂+ . . . +w_{N}P_{N} Expression (1)

As a result of each determination item being weighted, the item to be prioritized can be changed. When the weight of an item related to a passenger or an occupant of an oncoming vehicle is increased, the opinion of the passenger or the occupant who lives in the traveling region is significantly reflected in the evaluation. Regional characteristics can be incorporated into remote assistance services. For example, even when the approach distance to the control target vehicle is far, if many people press the danger notification button, an operation that allows leeway in distance is desired. In addition, if the weight is zero, the determination item of which the weight is zero is ignored.

Another example of the calculation formula for the overall score P(ALL) is shown in expression (2), below.

P(ALL)=A_{NG}×(w₁P₁+w₂P₂+ . . . +w_{N}P_{N}) Expression (2)

The above-described calculation formula (2) has a weight ANG that can set the overall score P(ALL) to zero when an extremely serious incident occurs. Ordinarily, A_{NG}=1. For example, a case in which a serious incident occurs is when the control target vehicle collides with an oncoming vehicle, when the oncoming vehicle is forced to apply sudden braking, and the like. As a result of A_{NG}=0 being set when a serious incident occurs, the overall score P(ALL) can be set to zero.

In addition, to prevent influence of a single evaluation from becoming unnecessarily high, the score P may be determined by a plurality of evaluations that include past evaluations. The calculation formula in this case is shown by expression (3), below.

P=w(−n)×P_{ALL}(−n)+ . . . +w(−1)×P_{ALL}(−1)+w(0)×P_{ALL}(0) Expression (3)

A current weight is w(0) and a current overall score P(ALL) is P_{ALL}(0). A weight one evaluation before is w(−1) and an overall score one evaluation before is P_{ALL}(−1). A weight n evaluations before is w(−n) and an overall score n evaluations before is P_{ALL}(−n).

As shown in expression (3), above, the score P is expressed by a weighted sum of the score P_{ALL}(0) to score P_{ALL}(−n). The overall score of each evaluation is determined by expression (1) or expression (2), above. How far back in evaluations is arbitrary.

In addition, as shown in expression (4), below, the score P may be a value that is obtained by the overall score P(ALL) determined by expression (1) or expression (2), above, being multiplied by a coefficient D. The coefficient D is a coefficient that is determined based on difficulty of the task. For example, a degree of difficulty differs between a task of remotely driving a vehicle and a task of issuing a remote instruction, such as a passing instruction, to a vehicle. Therefore, rather than these tasks having the same scores, a means for correction based on the degree of difficulty is provided. As a result of this correction, a difference in scores occurring as a result of the degree of difficulty of the task can be suppressed.

P=D×P(ALL) Expression (4)

In a table of scores shown in FIG. 16, an score P(1-3) that is based on the vehicle state of the oncoming vehicle is expressed by a weighted sum of the score P1, the score P2, and the score P3. As shown in FIG. 10, the score P1 is the score when the passing time interval of the oncoming vehicle exceeds the predetermined amount of time. The score P2 is the score when the inter-vehicle distance to the oncoming vehicle is less than the predetermined distance. The score P3 is the score when the deceleration of the oncoming vehicle is greater than the predetermined deceleration.

A score P(4-6) that is based on the passenger state of the control target vehicle is added points for each item. The score P(4-6) that is based on the passenger state of the control target vehicle is expressed by a weighted sum of a score P4, a score P5, and a score P6. The score P4 is a score when the danger notification rate from the passenger exceeds the predetermined rate. The score P5 is a score when the amount of change in the heart rate of the passenger exceeds the predetermined amount. The score P6 is a score when a fallen passenger is present. The determination items are similar to those according to the second embodiment (see FIG. 12).

A score P(7-9) that is based on the vehicle state and the occupant state of the oncoming vehicle is expressed by a weighted sum of a score P7, a score P8, and a score P9. The score P7 is a score when the danger notification from the occupant of the oncoming vehicle is present. The score P8 is a score when the deceleration of the oncoming vehicle is greater than the predetermined deceleration. The score P9 is the score when the approach distance to the control target vehicle is less than the predetermined distance. The determination items are similar to those according to the third embodiment (see FIG. 14).

A score P(10,11) that is based on the operating state of the operator is expressed as a weighted sum of a score P10 and a score P11. The score P10 is a score when the response time for the task exceeds the predetermined amount of time. The score P11 is an score when the processing time for the task exceeds the predetermined amount of time. The determination items are similar to those according to the fourth embodiment (see FIG. 15).

The overall score P(ALL) is obtained by the scores (scores P1 to P11) of the determination items being weighted and added together, rather than averaged. An allowable value is set for the overall score P(ALL). In addition, an allowable value may be set for each of the scores P1 to P11. For example, when the score P1 related to the passing time interval is less than the allowable value, as a result of A_{NG}=0 in expression (2), above, being set, a determination of incapability of performing duties can be made by this single determination item.

Here, the weighted sum of the scores P1 to P11 is the overall score P(ALL). However, the weighted sum of the score P(1-3), the score P(4-6), the score P(7-9), and the score (10,11) may be set as the overall score P(ALL). For example, in expression (1), above, as a result of each of the weights w₄ to w₁₁ that correspond to the scores P4 to P11 being set to zero, the score P(1-3) can be set as the overall score P(ALL).

The determination items used according to the first to fifth embodiments are examples. The determination items may be added, deleted, or modified according to a main purpose of each embodiment.

### (Evaluation Acquiring Process)

Next, a flow of the evaluation acquiring process will be described.

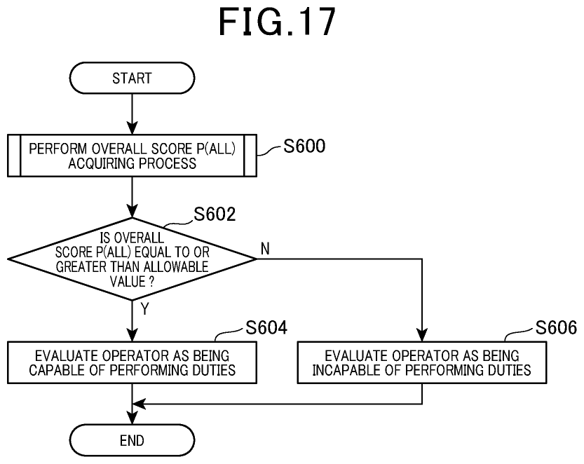

As shown in FIG. 17, in the evaluation acquiring process according to the fifth embodiment, first, at step S600, the CPU 31 performs an overall score P(ALL) acquiring process. In the overall score P(ALL) acquiring process, the score P1 to score P11 of the determination items are determined, and the overall score P(ALL) is calculated using the score P1 to score P11.

Next, at step S602, the CPU 31 determines whether the overall score P(ALL) is equal to or greater than an allowable value that is set in advance. When the overall score P(ALL) is equal to or greater than the allowable value, the CPU 31 proceeds to step S604. At step S604, the CPU 31 determines that the operator is capable of performing duties and ends the routine for the evaluation acquiring process. Meanwhile, when the overall score P(ALL) is less than the allowable value, the CPU 31 proceeds to step S606. At step S606, the CPU 31 determines that the operator is incapable of performing duties and ends the routine for the evaluation acquiring process.

According to the fifth embodiment, in addition to the effects according to the first embodiment, the evaluation of the operational capability of the operator can be expressed by points. In addition, as a result of a weighted sum of a plurality of scores that have differing bases for calculation being obtained, the opinion of each traffic participant can be widely incorporated. In a manner similar to that according to the second embodiment, an evaluation that reflects the circumstances of the traveling region can be achieved. This also leads to resolution of anxiety in the traffic participants towards remote control of the vehicle. Furthermore, as a result of the determination items being weighted, an item to be prioritized in the determination of the scores can be changed.

### Sixth Embodiment

According to a sixth embodiment, a return-to-duty process performed at step S120 in FIG. 5 will be described in detail.

### (Return-to-Duty Process)

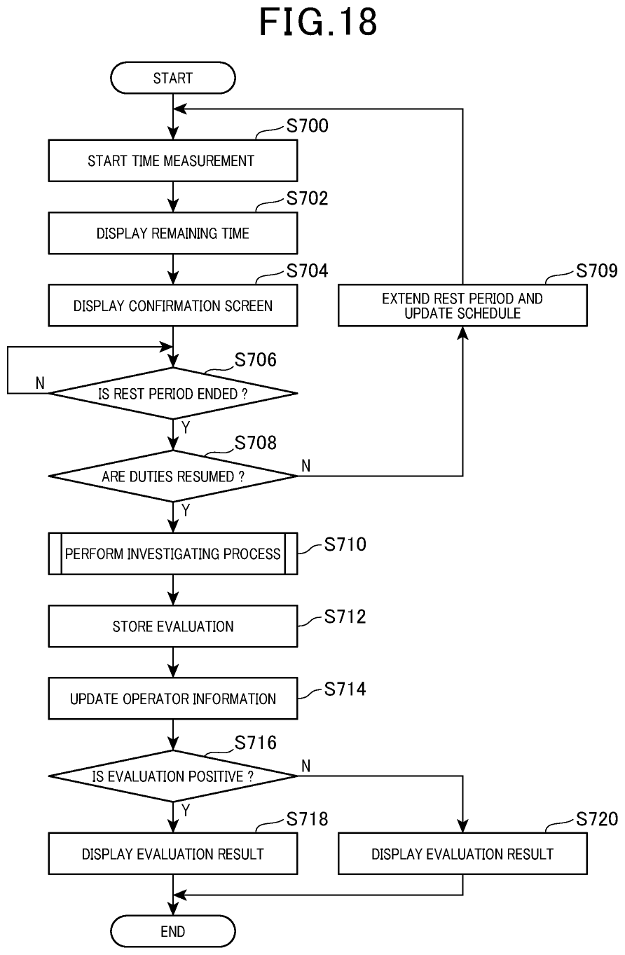

As shown in FIG. 18, in the return-to-duty process according to the sixth embodiment, first, at step S700, the CPU 31 starts measuring time. Next, at step S702, the CPU 31 generates data of a screen (such as a screen 74 in FIG. 20) for displaying a remaining rest period to the operator and transmits the data to the terminal apparatus 50. The CPU 31 causes the display unit 54 of the terminal apparatus 50 to display the screen. Acquisition of rest that is equal to or greater than a predetermined amount of time is a condition for returning to duty.

As shown in FIG. 20, on the screen 74, remaining time 76, such as 37 minutes and 12 seconds, is displayed. That is, time to resumption of duties is counted down.

Next, at step S704, the CPU 31 generates data of a confirmation screen (such as a screen 78 in FIG. 21) for confirming an intention to resume duties and transmits the data to the terminal apparatus 50. The CPU 31 causes the display unit 54 of the terminal apparatus 50 to display the confirmation screen. For example, the confirmation screen may be displayed such as to overlap the screen 74 that displays the remaining time 76.

As shown in FIG. 21, on the screen 78, in addition to a message 80 that confirms the intention to resume duties, such as “Press button below to resume duties,” a button 82 for requesting resumption of duties is displayed. The operator who wishes to return to duty presses the button 82 and requests resumption of duties before the rest period is ended. The operator can also extend the rest period without requesting resumption of duties.

Next, at step S706, the CPU 31 repeatedly determines whether the rest period is ended until the rest period ends. When the rest period ends, the CPU 31 proceeds to step S708.

Next, at step S708, the CPU 31 determines whether resumption of duties is requested. When the resumption of duties is requested, the CPU 31 proceeds to step S710. Meanwhile, when the resumption of duties is not request, the CPU 31 proceeds to step S709. At step S709, the CPU 31 extends the rest period, updates the schedule of the operator, and returns to step S700.

Next, at step S710, the CPU 31 performs an inspecting process for the operator whose status is suspended and acquires the evaluation result related to the operational capability of the operator.

Here, a flow of the inspecting process will be described.

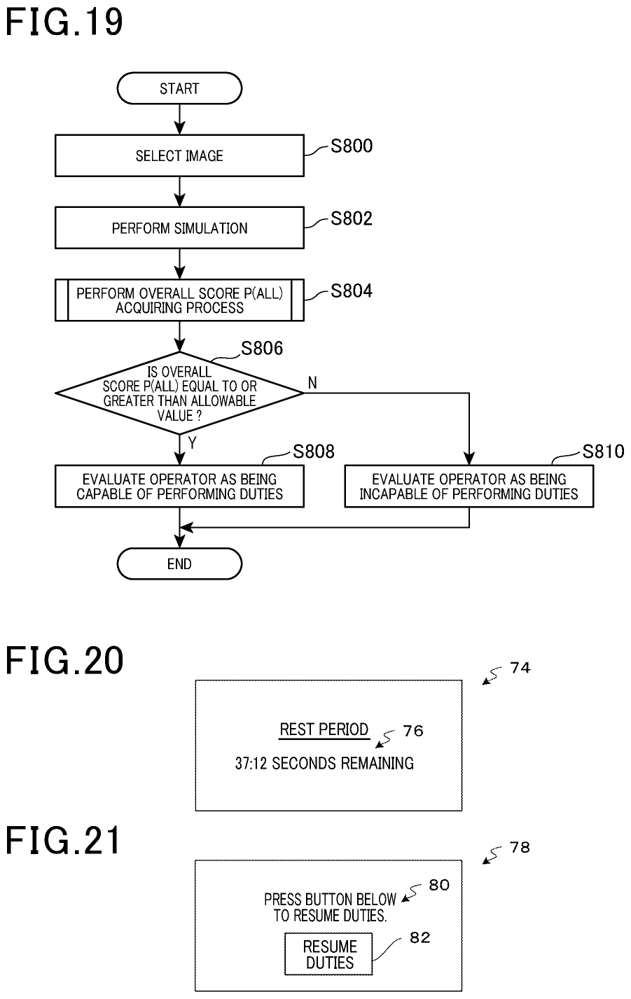

As shown in FIG. 19, first, at step S800, the CPU 31 selects conditions for a virtual task that is generated in a simulator. For example, the CPU 31 may select conditions such that weather conditions and time are similar to actual weather conditions and time at the time at which the inspection is performed. Conditions of a traffic environment that is used in the simulation is preferably selected from conditions of traffic environments of tasks that have been actually handled by other operators in the past. The conditions of a traffic environment are a position in which a peripheral traffic participant (such as a parked vehicle, a traveling vehicle, a bicycle, or a pedestrian) is present, speed and acceleration of the peripheral traffic participant, and the like.

Next, at step S802, the CPU 31 performs a simulation. As a result of the simulation, surrounding vehicles operate in response to operation of the control target vehicle, and the operational capability of the operator can be evaluated from the effects the operation by the operator has on the vicinity, in a manner similar to that when a task is performed. Next, at step S804, the CPU 31 performs the overall score P(ALL) acquiring process (see step S600 in FIG. 17). In the evaluation, a determination item that can be determined in the simulation may be used. The determination item may be selected from the determination items given as examples according to the first to fifth embodiments. Alternatively, other determination items may be added.

Next, at step 806, the CPU 31 determines whether the overall score P(ALL) is equal to or greater than an allowable value that is set in advance. When the overall score P(ALL) is equal to or greater than the allowable value, the CPU 31 proceeds to step S808. At step S808, the CPU 31 determines that the operator is capable of performing duties and ends the routine for the evaluation acquiring process. Meanwhile, when the overall score P(ALL) is less than the allowable value, the CPU 31 proceeds to step S810. At step S810, the CPU 31 determines that the operator is incapable of performing duties and ends the routine for the evaluation acquiring process.

Here, the description will return to FIG. 18. Next, at step S712, the CPU 31 stores the evaluation result acquired at step S710 in the management information DB 45 in association with the operator.

Next, at step S714, the CPU 31 changes the status of the operator based on the evaluation result acquired at step S710, and updates the schedule and the newest evaluation result of the operator.

Next, at step S716, the CPU 31 determines whether the evaluation result acquired at step S710 is a positive evaluation result. When the evaluation result is a positive evaluation result, the CPU 31 proceeds to step S718. When the evaluation result is a negative evaluation result, the CPU 31 proceeds to step S720.

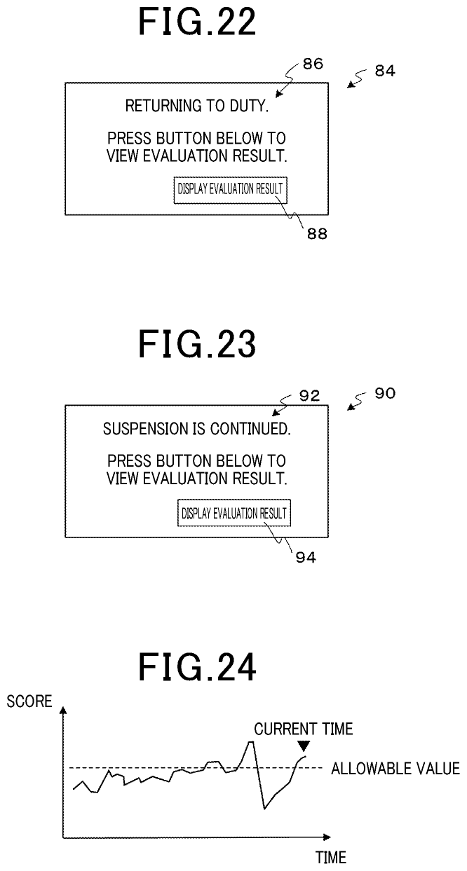

Next, at step S718, the CPU 31 generates data for a screen (such as a screen 84 in FIG. 22) for displaying the positive evaluation result to the operator and transmits the data to the terminal apparatus 50. The CPU 31 causes the display unit 54 of the terminal apparatus 50 to display the screen and ends the program.

As shown in FIG. 22, on the screen 84, a message 86 that communicates the positive evaluation result and prompts confirmation of the evaluation result, such as “Returning to duty. Press button below to view evaluation result,” and a button 88 for instructing display of the evaluation result are displayed. When the button 88 is pressed, a detailed evaluation result is displayed.

Meanwhile, at step S720, the CPU 31 generates data for a screen (such as a screen 90 in FIG. 23) for displaying the negative evaluation result to the operator and transits the data to the terminal apparatus 50. The CPU 31 causes the display unit 54 of the terminal apparatus 50 to display the screen and ends the program.

As shown in FIG. 23, on the screen 90, a message 92 that communicates the negative evaluation result and prompts confirmation of the evaluation result, such as “Suspension is continued. Press button below to view evaluation result,” and a button 94 for instructing display of the evaluation result are displayed. When the button 94 is pressed, a detailed evaluation result is displayed.

Here, a display example of the detailed evaluation result will be described.

For example, as shown in FIG. 24, a graph that shows changes over time in the scores and the allowable value of the score may be displayed as the detailed evaluation result. A section in which the score significantly decreases, that is, a section of the evaluation result that denies capability of performing duties may be displayed in an emphasized manner, such as a color being changed or shading being added. The operator can confirm a current score and fluctuations in the score up to the present.

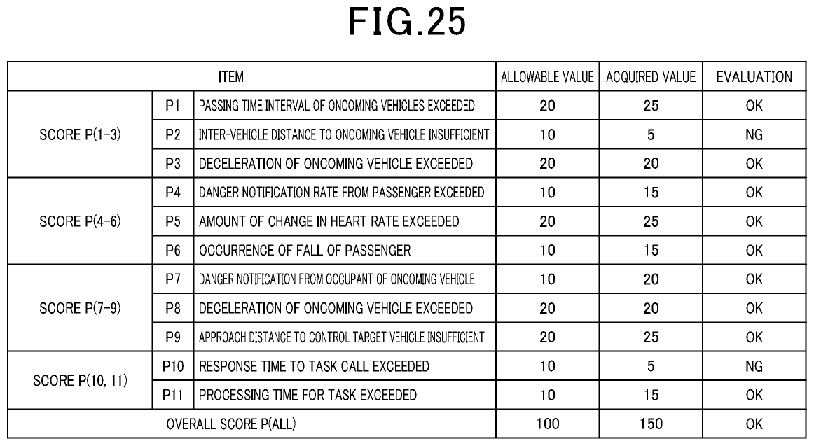

Alternatively, as shown in FIG. 25, a table that shows an acquired value of the score, the allowable value, and capability/incapability of performing duties for each determination item may be displayed as the detailed evaluation result. The operator can confirm details of the evaluation such as the determination item of which the score is lower than the allowable value and in which capability of performing duties is judged to be insufficient.

Here, the inspecting process using the simulation may be performed on operators of other statuses.

For example, there are operators who have not been evaluated for an amount of time prescribed in advance or longer, such as an operator who has extended the rest period or an operator who has not been assigned a task for an extended amount of time. Regarding the operator who has not been evaluated for the amount of time prescribed in advance or longer, as well, the status may be changed from “standing by” to “suspended,” assignment of a task may be prohibited, and inspection for returning to duty may be required. In this case, when a request to resume duties is received from the operator, the processes from step S710 to step S720 in FIG. 18 are performed and the evaluation result is acquired.

When a period over which evaluation is not performed increases, reliability of the acquired evaluation results decreases. An opportunity to acquire a new evaluation result can be provided to the operator who has not been evaluated for an extended amount of time. In addition, the physical condition of the operator can be periodically confirmed.

Furthermore, regarding the operator whose status is “preparing,” receiving the inspection for returning to duty and acquiring a positive evaluation result may be a condition for starting duties. Decrease in operational capability of the operator can be detected in advance. In this case, when a request for starting duties is received from the operator, the processes at step S710 to step S720 in FIG. 18 are performed and the evaluation result is acquired.

According to the sixth embodiment, the operator can be allowed to return to duty upon recovery of the operational capability of the operator being confirmed. In addition, compared to when the operator is not allowed to return to duty, the remote assistance system can be efficiently operated without increase in operators.

### Seventh Embodiment

According to a seventh embodiment, assignment of the task is performed based on the score.

An example of a table that shows a relationship between types of tasks and the allowable values of the score is shown in Table 2, below.

TABLE 2

| Type of task | Allowable value of score |
|---|---|
| Remote control | 120 |
| Passenger response | 100 |

As described above, remote control includes remote driving in which the operator performs a driving operation of the vehicle and remote instruction in which the operator issues a direct traveling instruction to the vehicle. For example, the operator may issue instructions such as permission to pass and permission to change traffic lanes. In addition, passenger response is, for example, a task in which the operator responds to a call from a passenger, such as by answering a question from a passenger.

According to the fifth and sixth embodiments, when the score of the operator is less than the predetermined allowable value, assignment of all tasks to the operator is prohibited. In contrast, according to the seventh embodiment, even when the operator cannot acquire the required score for remote control, if the operator acquires the required score for passenger response, the operator is assigned the task of passenger response.

For example, the allowable value of the score for remote control may be 120 and the allowable value of the score for passenger response may be 100. The operator whose score is equal to or greater than 120 can be assigned both remote control and passenger response. The operator whose score is equal to or greater than 100 and less than 120 is prohibited from being assigned remote control but can be assigned passenger response. The operator whose score is less than 100 is prohibited from being assigned both remote control and passenger response.

Here, when the score is equal to or greater than 120, the status of the operator is “standing by.” When the score is less than 120, the status of the operator is “suspended.”

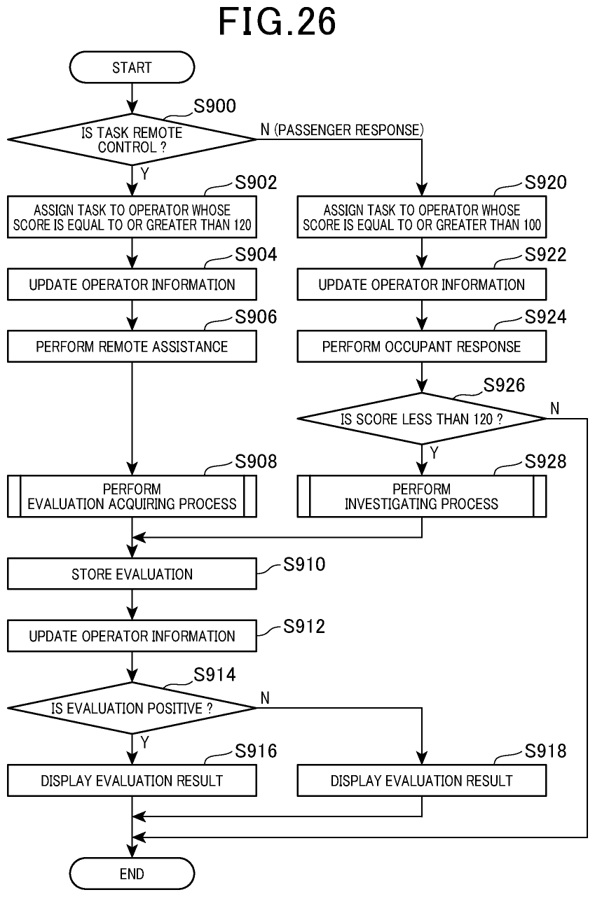

A remote assistance program according to the seventh embodiment shown in FIG. 26 is performed by the CPU 31 of the remote assistance apparatus 30 when a request is received from the vehicle 10 (see FIG. 2).

First, at step S900, the CPU 31 determines whether the requested task is remote control. When the requested task is remote control, the CPU 31 proceeds to step S902.

Next, at step S902, the CPU 31 references the management table shown in FIG. 4 and selects a single operator whose schedule is free from among the plurality of operators whose scores are equal to or greater than 120. Then, the CPU 31 assigns the task to the selected operator.

Next, at step S904, the CPU 31 changes the status of the operator to whom the task is assigned from “standing by” to “in progress” and updated the schedule of the operator.

Next, at step S906, the CPU 31 causes the operator who is assigned the task to remotely operate the vehicle 10. The operator operates the corresponding terminal apparatus 50 and performs the assigned task.

Next, at step S908, the CPU 31 performs the “evaluation acquiring process” to acquire the evaluation result related to the operational capability of the operator when the operator performs the task. The CPU 31 proceeds to step S910. Here, in a manner similar to that at step S600 in FIG. 17 and step S804 in FIG. 19, the CPU 31 performs the “overall score P(ALL) acquiring process.”

Meanwhile, when determined that the requested task is not remote control, the CPU 31 proceeds to step S920 because the requested task is passenger response.

Next, at step S920, the CPU 31 references the management table shown in FIG. 4 and selects a single operator whose schedule is free from among the plurality of operators whose scores are equal to or greater than 100. Then, the CPU 31 assigns the task to the selected operator.

Next, at step S922, the CPU 31 changes the status of the operator to whom the task is assigned from “standing by” to “in progress” and updated the schedule of the operator.

Next, at step S924, the CPU 31 requests that the operator to whom the task is assigned response to the passenger of the vehicle 10. The operator operates the corresponding terminal apparatus 50 and performs the assigned task.

Next, at step S926, the CPU 31 determines whether the score of the operator is equal to or greater than 100. When the operator whose score is less than 120 is selected, at step S928, the CPU 31 performs the “inspecting process” and proceeds to step S910. When the score of the operator is equal to or greater than 120 in this inspection, the operator can return to the duty of remote control.

Next, at step S910, the CPU 31 stores the acquired evaluation result in the management information DB 45 in association with the operator.

Next, at step S912, the CPU 31 changes the status of the operator based on the evaluation result, and updates the schedule and the newest evaluation result of the operator.

Next, at step S914, the CPU 31 determines whether the acquired evaluation result is a positive evaluation result. When the evaluation result is a positive evaluation result, the CPU 31 proceeds to step S916.

Next, at step S916, the CPU 31 generates data of a screen that displays the positive evaluation result to the operator and transmits the data to the terminal apparatus 50. The CPU 31 causes the display unit 54 of the terminal apparatus 50 to display the screen and ends the program. Meanwhile, at step S918, the CPU 31 generates data of a screen that displays the negative evaluation result to the operator and transmits the data to the terminal apparatus 50. The CPU 31 causes the display unit 54 of the terminal apparatus 50 to display the screen and ends the program.

According to the seventh embodiment, a light task can be assigned to the operator based on a degree of fatigue of the operator. In addition, compared to when assignment of all tasks to the operator is prohibited, the remote assistance system can be efficiently operated without increase in the number of operators.

### [Modifications]

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

The flow of processes of the programs described according to the above-described embodiments may be also an example. Unnecessary steps may be eliminated, new steps may be added, and order of processes may be interchanged without departing from the main purpose.

In addition, according to the above-described embodiments, a case in which the processes according to the embodiment are actualized by a software configuration using a computer by a program being run is described. However, this is not limited thereto. For example, the processes may be actualized by a hardware configuration or a combination of a hardware configuration and a software configuration.

What is claimed is:

1. A remote assistance apparatus comprising:
a task assigning unit that prohibits assignment of a task to an operator whose operational capability is judged to be insufficient by newest evaluation results that are stored in a storage unit, and assigns a task of remotely controlling a vehicle to an operator who is selected from among a plurality of operators whose operating abilities are judged to be sufficient by the newest evaluation results;
an evaluation acquiring unit that acquires the evaluation result of the operational capability of the selected operator, in response to the selected operator performing the task that is assigned by the task assigning unit using a remote control unit that causes the vehicle to travel in response to remote control by the operator; and
a storage control unit that performs control to store the newest evaluation result acquired by the evaluation acquiring unit in the storage unit.

2. The remote assistance apparatus according to claim 1, wherein:
the evaluation acquiring unit acquires, using a simulator unit that performs a simulation that causes the vehicle to travel in a virtual environment in response to operation by the operator, a new evaluation result of operational capability of: an operator whose operational capability is judged to be insufficient by the newest evaluation results; or an operator whose new evaluation result of operational capability has not been acquired for an amount of time prescribed in advance or longer.

3. The remote assistance apparatus according to claim 1, wherein:
the evaluation result is an evaluation result that is based on movement of another vehicle that is traveling in a vicinity of an assistance target vehicle in response to the operation by the operator, and is acquired by the evaluation acquiring unit of an own apparatus or acquired by the assistance target vehicle and transmitted to the own apparatus.

4. The remote assistance apparatus according to claim 1, wherein:
the evaluation result is an evaluation result that is based on movement of a passenger of an assistance target vehicle in response to the operation by the operator, and is acquired by the evaluation acquiring unit of an own apparatus or acquired by the assistance target vehicle and transmitted to the own apparatus.

5. The remote assistance apparatus according to claim 1, wherein:
the evaluation result is an evaluation result that is based on movement of another vehicle that is traveling in a vicinity of an assistance target vehicle and movement of an occupant of the other vehicle in response to the operation by the operator, and is acquired by the evaluation acquiring unit of an own apparatus or acquired by the other vehicle and transmitted to the own apparatus.

6. The remote assistance apparatus according to claim 1, wherein:
the evaluation result is an evaluation result that is based on an operating state of the operator and is acquired by the evaluation acquiring unit of an own apparatus.

7. The remote assistance apparatus according to claim 1, wherein:
the evaluation result is expressed by capability/incapability of performing duties; and
the task assigning unit assigns the task to the operator who is capable of performing duties.

8. The remote assistance apparatus according to claim 1, wherein:
the evaluation result is expressed by a score that expresses the operational capability of the operator; and
the task assigning unit assigns the task to the operator whose score is equal to or greater than an allowable value that is prescribed in advance.

9. The remote assistance apparatus according to claim 1, wherein:
the evaluation result is expressed by a score that expresses the operational capability of the operator; and
the task assigning unit holds a relationship between types of tasks and allowable values, and assigns the task to the operator who has a score that is equal to or greater than the allowable value that corresponds to the type of the assigned task.

10. The remote assistance apparatus according to claim 8, wherein:
the score is expressed by a weighted sum of a plurality of scores that have differing bases of calculation that are calculated for a single task by a certain operator.

11. The remote assistance apparatus according to claim 8, wherein:
the score is expressed by a weighted sum of a plurality of scores that are calculated for a plurality of tasks by a certain operator.

12. The remote assistance apparatus according to claim 1, further comprising:
a display control unit that causes a display unit of a terminal apparatus that is used by the operator to display various types of screens, wherein
the display control unit causes the display unit to display a result display screen that displays the evaluation result.

13. The remote assistance apparatus according to claim 12, wherein:
when the evaluation result is expressed by the score that expresses the operational capability of the operator,
the result display screen includes at least either of a current score and changes over time in the score.

14. The remote assistance apparatus according to claim 12, wherein:
when the operational capability is judged to be insufficient by the evaluation result,
the result display screen includes notice that assignment of tasks is stopped.

15. The remote assistance apparatus according to claim 2, further comprising:
a display control unit that causes a display unit of a terminal apparatus that is used by the operator to display various types of screens, wherein
the display control unit displays a result display screen that includes notice that assignment of a task is stopped, and after elapse of an amount of time that is prescribed in advance, subsequently displays an instruction receiving screen that includes an instructing unit that instructs start of the simulation.

16. The remote assistance apparatus according to claim 2 wherein:
an image that is used in the simulation is an image of a vicinity of a vehicle that includes conditions of a traffic environment that is identical to that of a previous task by another operator.

17. A non-transitory computer-readable storage medium storing therein a program for causing a computer to function as:
a task assigning unit that assigns a task of remotely controlling a vehicle to an operator who is selected from among a plurality of operators whose operating abilities are judged to be sufficient by newest evaluation results that are stored in a storage unit;
an evaluation acquiring unit that acquires the evaluation result of the operational capability of the selected operator, in response to the selected operator performing the task that is assigned by the task assigning unit, using a remote control unit that causes the vehicle to travel in response to remote control by the operator; and
a storage control unit that performs control to store the newest evaluation result acquired by the evaluation acquiring unit in the storage unit.

18. The non-transitory computer-readable storage medium according to claim 17, wherein:
the evaluation acquiring unit acquires, using a simulator unit that performs a simulation that causes the vehicle to travel in a virtual environment in response to operation by the operator, a new evaluation result of operational capability of: an operator whose operational capability is judged to be insufficient by the newest evaluation results; or an operator whose new evaluation result of operational capability has not been acquired for an amount of time prescribed in advance or longer.

19. A remote assistance method comprising:
prohibiting assignment of a task to an operator whose operational capability is judged to be insufficient by newest evaluation results that are stored in a storage unit, and assigning a task of remotely controlling a vehicle to an operator who is selected from among a plurality of operators whose operating abilities are judged to be sufficient by the newest evaluation results;
acquiring the evaluation result of the operational capability of the selected operator, in response to the selected operator performing the assigned task using a remote control unit that causes the vehicle to travel in response to remote control by the operator; and
performing control to store the newest evaluation result acquired by the evaluation acquiring unit in the storage unit.

20. The remote assistance method according to claim 19, further comprising:
acquiring, using a simulator unit that performs a simulation that causes the vehicle to travel in a virtual environment in response to operation by the operator, a new evaluation result of operational capability of: an operator whose operational capability is judged to be insufficient by the newest evaluation results; or an operator whose new evaluation result of operational capability has not been acquired for an amount of time prescribed in advance or longer.
